(19) United States
(12) Patent Application Publication
(10) Pub. No.: US 2025/0316686 A1
(43) Pub. Date: Oct. 9, 2025

(54) SECONDARY BATTERY AND ELECTRONIC APPARATUS

(71) Applicant: Dongguan Amperex Technology Limited, Dongguan (CN)

(72) Inventors: Xiaoping LIN, Dongguan (CN); Yuansen XIE, Dongguan (CN)

(73) Assignee: Dongguan Amperex Technology Limited, Dongguan (CN)

(21) Appl. No.: 19/003,348

(22) Filed: Dec. 27, 2024

(30) Foreign Application Priority Data
Dec. 29, 2023 (CN) 202311874127.1

(51) Int. Cl. H01M 4/36; H01M 4/02; H01M 4/131; H01M 4/505; H01M 4/525; H01M 10/0525; H01M 10/0562

(52) U.S. Cl. CPC H01M 4/366; H01M 4/131; H01M 4/505; H01M 4/525; H01M 10/0562; H01M 2004/021; H01M 2004/028; H01M 10/0525

(57) ABSTRACT

A secondary battery comprising positive electrode active material. The positive electrode active material includes a positive electrode active material substrate and a solid electrolyte material. The positive electrode active material substrate includes a first element, and the solid electrolyte material includes a second element. A weight percentage of any one of the second element in a surface region of particles of the positive electrode active material is 1000 ppm to 20000 ppm, and a weight percentage of any one of the second element in an internal region of particles of the positive electrode active material is less than 500 ppm.

### CROSS-REFERENCE TO RELATED APPLICATION

The present application claims priority to Chinese Patent application No. CN 202311874127.1 filed in the China National Intellectual Property Administration on Dec. 29, 2023, the entire content of which is hereby incorporated by reference.

### TECHNICAL FIELD

This application relates to the field of electrochemical technologies, and in particular, to a secondary battery and an electronic apparatus.

### BACKGROUND

Currently, with increasingly wide application of lithium-ion batteries, charge and discharge rate performance, high- and low-temperature performance, safety performance and the like of lithium-ion batteries require continuous improvement. Currently, kinetics of electrode plates is generally improved through the following means: (1) perforation processing at electrode plate level: making electrode plates porous to improve the wettability of electrolyte solutions, thereby enhancing lithium-ion conduction; and (2) coating at material level: coating surfaces of positive electrode active materials and negative electrode active materials with materials exhibiting excellent ionic conduction to increase the ionic conduction at interfaces between positive electrode active materials and negative electrode active materials. The foregoing means to enhance kinetics of electrode plates require performing perforation processing on electrode plates or surface-treating on materials. First, the process is difficult and costly; and second performing perforation processing on electrode plates also leads to a loss in energy density of lithium-ion batteries.

Additionally, coating separators with coatings is typically used to improve the safety performance of lithium-ion batteries. However, coating separators with coatings involves a complex process and is also costly. Therefore, there is an urgent need to provide a lithium-ion battery with low impedance and good rate performance, cycling performance, and safety performance.

### SUMMARY

This application is intended to provide a secondary battery and an electronic apparatus to reduce impedance of the secondary battery and improve the rate performance, cycling performance, and safety performance of the secondary battery. Specific technical solutions are as follows:

A first aspect of this application provides a secondary battery including a positive electrode plate, a negative electrode plate, and an electrolyte solution, where the positive electrode plate includes a positive electrode current collector and a positive electrode material layer disposed on at least one surface of the positive electrode current collector, the positive electrode material layer includes a positive electrode active material, the positive electrode active material includes a positive electrode active material substrate and a solid electrolyte material, and at least part of the solid electrolyte material is disposed on a surface of the positive electrode active material substrate. The positive electrode active material substrate includes a first element, where the first element includes at least one of Ni, Mn, Fe, or Co; and the solid electrolyte material includes a second element, where the second element includes at least one of Al, Ge, Sr, Hf, Si, Zn, Cl, I, Mg, Ca, Ba, La, Ti, Zr, P, or Ta. A particle of the positive electrode active material comprise a surface region and an internal region, wherein the surface region is a region from a surface of the particle to a depth of M nm inside the particle, 1≤M≤300, and the internal region is a region in the positive electrode active material other than the surface region. Based on a weight of the positive electrode active material, a weight percentage of any one of the second element in the surface region is 1000 ppm to 20000 ppm, and a weight percentage of any one of the second element in the internal region is less than 500 ppm. Controlling the positive electrode active material to include the positive electrode active material substrate and the solid electrolyte material, the positive electrode active material substrate to include the first element, the solid electrolyte material to include the second element, and the weight percentage of any one of the at least one second element in the surface region and the weight percentage of any one of the at least one second element in the internal region to fall within the ranges specified in this application can reduce the impedance of the secondary battery, and improve the rate performance, cycling performance, and safety performance of the secondary battery.

In an embodiment of this application, based on a mass of the positive electrode material layer, a weight percentage W2 of the solid electrolyte material is 0.2% to 10%. Controlling the weight percentage W2 of the solid electrolyte material to fall within the range specified in this application can allow the solid electrolyte material on the surface of the positive electrode active material substrate to have an appropriate thickness, thereby further enhancing the stability of the positive electrode active material substrate, improving the safety performance of the secondary battery, reducing the impedance of the secondary battery, and improving the cycling performance and rate performance of the secondary battery.

In an embodiment of this application, a scanning electron microscope and energy spectrum analyzer is used to perform line scan on the particles of the positive electrode active material in a cross-section of the positive electrode material layer, the line scan includes three straight lines, the three straight lines intersect each other at an angle of 60° with each straight line being 20 μm to 100 μm in length, in a line scan spectrum of at least any two straight lines, there are x first peaks of any one of the first element, there are y second peaks of any one of the second element, with y=2x, and a peak top region of the first peak corresponds to a peak top region of the second peak. The line scan spectrum meeting the above characteristic indicates that the solid electrolyte material is present on the surface of the positive electrode active material substrate and that the solid electrolyte material is uniformly distributed on the surface of the positive electrode active material substrate. This can improve lithium-ion conduction inside the positive electrode plate, reduce side reactions between the positive electrode active material and the electrolyte solution, and improve the cycling performance, rate performance, and safety performance of the secondary battery.

In an embodiment of this application, the positive electrode material layer includes at least one of Al, La, Ti, or Zr, and based on a mass of the positive electrode material layer, the positive electrode material layer satisfies at least one of the following characteristics:
(1) the positive electrode material layer includes Al, and a weight percentage W3 of Al is 42 ppm to 3000 ppm and preferably W3 is 211 ppm to 2110 ppm; (2) the positive electrode material layer includes La, and a weight percentage W4 of La is 1600 ppm to 50000 ppm; (3) the positive electrode material layer includes Ti, and a weight percentage W5 of Ti is 425 ppm to 35000 ppm and preferably W5 is 2126 ppm to 21261 ppm; or (4) the positive electrode material layer includes Zr, and a weight percentage W6 of Zr is 720 ppm to 25000 ppm.

In an embodiment of this application, an average particle size of the positive electrode active material is 5 μm to 30 μm, and preferably the average particle size of the positive electrode active material is 8 μm to 20 μm. Controlling the average particle size of the positive electrode active material to fall within the range specified in this application can allow the positive electrode active material to have an appropriate average particle size, further improving lithium-ion conduction inside the positive electrode plate, further reducing the impedance of the secondary battery, enhancing the kinetics of the secondary battery, and further improving the cycling performance and rate performance of the secondary battery.

In an embodiment of this application, a specific surface area B of the positive electrode active material is 0.2 m²/g to 0.8 m²/g, and preferably the specific surface area B of the positive electrode active material is 0.28 m²/g to 0.41 m²/g. Controlling the specific surface area B of the positive electrode active material to fall within the range specified in this application can allow the positive electrode active material to have an appropriate specific surface area, further improving lithium-ion conduction inside the positive electrode plate, further reducing the impedance of the secondary battery, enhancing the kinetics of the secondary battery, and further improving the cycling performance and rate performance of the secondary battery.

In an embodiment of this application, a porosity of the positive electrode plate is 18% to 30%. Controlling the porosity of the positive electrode plate to fall within the range specified in this application can allow the positive electrode plate to have an appropriate porosity, so that the secondary battery has low impedance, good rate performance, good cycling performance, and good safety performance while also having relatively high energy density.

In an embodiment of this application, the solid electrolyte material comprises at least one selected from the group consisting of the following compounds and the following compounds with a doping element: NASICON-structured Li₁₊ₓ₁Alₓ₁Ge₂₋ₓ₁(PO₄)₃, NASICON-structured Li₁₊ₓ₂Alₓ₂Ti₂₋ₓ₂(PO₄)₃, perovskite-structured Li₃ₓ₃La_{2/3-x3}TiO₃, perovskite-structured Li_{3/8}Sr_{7/16}Ta_{3/4}Hf_{1/4}O₃, perovskite-structured Li_{2x4-y1}Sr₁₋ₓ₄Ta_{y1}Zr_{1-y1}O₃, anti-perovskite-structured Li₃₋₂ₓ₅Mₓ₅HalO, anti-perovskite-structured Li₃OCl, LISICON-structured Li₄₋ₓ₆Si₁₋ₓ₆Pₓ₆O₄, LISICON-structured Li₁₄ZnGe₄O₁₆, and garnet-structured Li₇₋ₓ₇La₃Zr₂₋ₓ₇O₁₂, wherein 0<x1≤0.75, 0<x2≤0.5, 0.1≤x3≤0.3, 0.25≤y1≤1, x4=0.75y1, 0≤x5≤0.01, 0.5≤x6≤0.6, 0≤x7≤1, M comprises at least one of Mg, Ca, Sr, or Ba, and Hal comprises at least one of Cl or I; wherein the doping element comprises at least one of Sn, Si, Ge, Sr, Ta, or Ce.

Selecting the above solid electrolyte material can further improve lithium-ion conduction inside the positive electrode plate, further reduce the impedance of the secondary battery, enhancing the kinetics of the secondary battery, and further improve the cycling performance and rate performance of the secondary battery.

In an embodiment of this application, an ionic conductivity of the solid electrolyte material is 8×10⁻⁵ S/cm to 1×10⁻³ S/cm, and/or an electronic conductivity of the solid electrolyte material is 1×10⁻¹⁴ S/cm to 1×10⁻⁸ S/cm. The ionic conductivity and electronic conductivity of the solid electrolyte material falling within the ranges specified in this application can accelerate lithium-ion conduction inside the positive electrode plate, further reduce the impedance of the secondary battery, and improve the kinetics of the secondary battery, thereby further enhancing the cycling performance and rate performance of the secondary battery.

In an embodiment of this application, the electrolyte solution includes a lithium salt, the lithium salt includes a first fluorine-containing lithium salt and/or a second fluorine-containing lithium salt, the first fluorine-containing lithium salt includes lithium hexafluorophosphate, and the second fluorine-containing lithium salt includes one of lithium bis(fluorosulfonyl)imide, lithium bis(trifluoromethylsulfonyl)imide, lithium tetrafluoroborate, lithium difluorooxalate borate, lithium bis(oxalate)borate, or lithium difluorophosphate; where based on a mass of the electrolyte solution, a weight percentage A1 of the first fluorine-containing lithium salt is 4.6% to 22.09%, and a weight percentage A2 of the second fluorine-containing lithium salt is 0.46% to 11.1%. Controlling the lithium salt in the electrolyte solution to include the first fluorine-containing lithium salt and/or the second fluorine-containing lithium salt, the types and proportions of the first fluorine-containing lithium salt and second fluorine-containing lithium salt to fall within the ranges specified in this application can allow a solid electrolyte material interphase (SEI) film formed on the surface of the negative electrode plate to have appropriate weight percentages of Li and F. This can increase the inorganic proportion in the SEI film and improve the ionic conduction of the SEI film, thereby further enhancing the cycling performance and rate performance of the secondary battery.

In an embodiment of this application, based on a mass of the negative electrode material layer, a weight percentage W7 of the first element is 0.01% to 0.1%, where 4.6×10⁻⁷≤A2×W7≤1.11×10⁻⁴. Controlling the weight percentage W7 of the first element and the value of A2×W7 to fall within the ranges specified in this application can allow the weight percentage A2 of the second fluorine-containing lithium salt to match with the weight percentage W7 of the first element, and the electrolyte solution to synergize with the positive electrode active material. This reduces dissolution of transition metal from the positive electrode active material substrate, and further improves the safety performance of the secondary battery.

A second aspect of this application provides an electronic apparatus including the secondary battery according to any one of the foregoing embodiments. Therefore, the electronic apparatus provided in this application has good usage performance.

This application has the following beneficial effects:

This application provides the secondary battery and the electronic apparatus. The secondary battery includes the positive electrode plate, the negative electrode plate, and the electrolyte solution, where the positive electrode plate includes the positive electrode current collector and the positive electrode material layer disposed on at least one surface of the positive electrode current collector, the positive electrode material layer includes the positive electrode active material, the positive electrode active material includes the positive electrode active material substrate and the solid electrolyte material, and at least part of the solid electrolyte material is disposed on the surface of the positive electrode active material substrate. The positive electrode active material substrate includes the first element, where the first element includes at least one of Ni, Mn, Fe, or Co; and the solid electrolyte material includes the second element, where the second element includes at least one of Al, Ge, Sr, Hf, Si, Zn, Cl, I, Mg, Ca, Ba, La, Ti, Zr, P, or Ta. The particles of the positive electrode active material include the surface region and the internal region, where the surface region is a region from the surface of the particles to the internal location with a depth of 1 nm to 300 nm of the particles, and the internal region is a region of the positive electrode active material other than the surface region. Based on the mass of the positive electrode active material, the weight percentage of any one of the at least one second element in the surface region is independently 1000 ppm to 20000 ppm, and the weight percentage of any one of the at least one second element in the internal region is independently less than 500 ppm. Controlling the positive electrode active material to include the positive electrode active material substrate and the solid electrolyte material, the positive electrode active material substrate to include the first element, the solid electrolyte material to include the second element, and the weight percentage of any one of the at least one second element in the surface region and the weight percentage of any one of the at least one second element in the internal region to fall within the ranges specified in this application can reduce the impedance of the secondary battery, and improve the rate performance, cycling performance, and safety performance of the secondary battery.

Certainly, when any one of the products or methods of this application is implemented, all advantages described above are not necessarily demonstrated simultaneously.

### BRIEF DESCRIPTION OF DRAWINGS

To describe the technical solutions in the embodiments of this application or in the prior art more clearly, the following briefly describes the accompanying drawings for describing the embodiments or the prior art. Apparently, the accompanying drawings in the following description show merely some embodiments of this application, and persons of ordinary skill in the art may still derive other embodiments from these accompanying drawings without creative efforts.

FIG. 1 is a schematic structural diagram of a positive electrode active material in a positive electrode plate;

FIG. 2 is a scanning electron microscope image at 3000× magnification of a positive electrode active material in Example 1-1 of this application;

FIG. 3 is a scanning electron microscope image at 30000× magnification of a positive electrode active material in Example 1-1 of this application;

FIG. 4 is a scanning electron microscope image at 3000× magnification of a positive electrode active material in Comparative Example 1 of this application;

FIG. 5 is a scanning electron microscope image at 30000× magnification of a positive electrode active material in Comparative Example 1 of this application;

FIG. 6 is a surface scan element distribution diagram of a positive electrode plate in Example 1-11 of this application; and

FIG. 7 is a cross-sectional scanning electron microscope image of particles of a positive electrode material layer in Example 1-1 of this application.

### DETAILED DESCRIPTION

The following clearly and completely describes the technical solution in the embodiments of this application with reference to the accompanying drawings in the embodiments of this application. Apparently, the described embodiments are only some rather than all of the embodiments of this application. All other embodiments obtained by persons skilled in the art based on this application shall fall within the protection scope of this application.

It should be noted that in specific embodiments of this application, an example in which a lithium-ion battery is used as a secondary battery is used to illustrate this application. However, the secondary battery in this application is not limited to the lithium-ion battery.

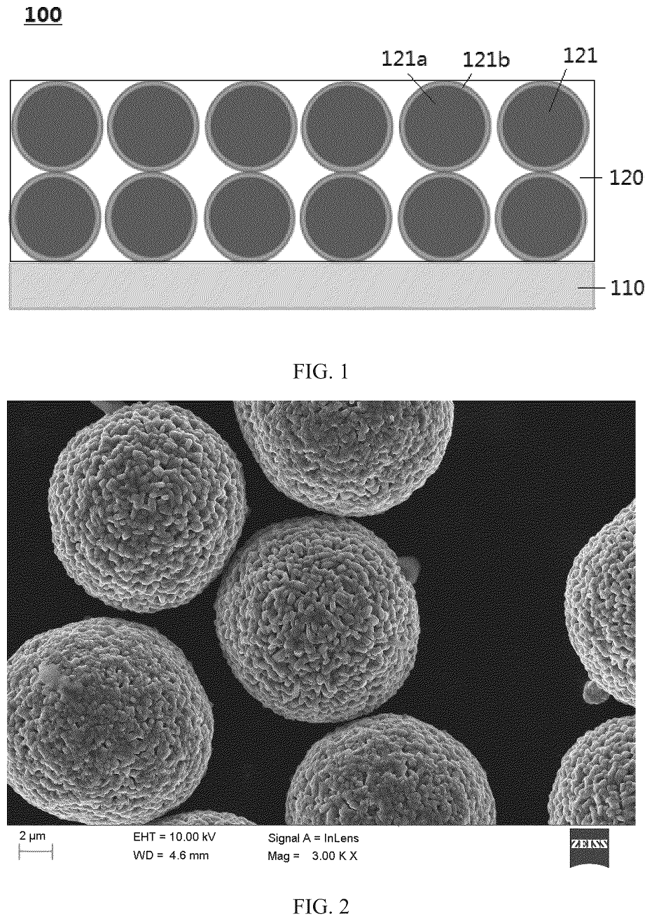

This application provides a secondary battery including a positive electrode plate, a negative electrode plate, and an electrolyte solution, where the positive electrode plate includes a positive electrode current collector and a positive electrode material layer disposed on at least one surface of the positive electrode current collector, the positive electrode material layer includes a positive electrode active material, the positive electrode active material includes a positive electrode active material substrate and a solid electrolyte material, and at least part of the solid electrolyte material is disposed on a surface of the positive electrode active material substrate. As shown in FIG. 1, a positive electrode plate 100 includes a positive electrode current collector 110 and a positive electrode material layer 120 disposed on one surface of the positive electrode current collector 110. The positive electrode material layer 120 includes a positive electrode active material 121. The positive electrode active material 121 includes a positive electrode active material substrate 121a and a solid electrolyte material 121b. The solid electrolyte material 121b is disposed on a surface of the positive electrode active material substrate 121a. The “at least part of the solid electrolyte material is disposed on the surface of the positive electrode active material substrate” means that the solid electrolyte material can be present on part of the surface or the entire surface of the positive electrode active material substrate. The positive electrode active material substrate includes a first element, where the first element includes at least one of Ni, Mn, Fe, or Co; and the solid electrolyte material includes a second element, where the second element N includes at least one of Al, Ge, Sr, Hf, Si, Zn, Cl, I, Mg, Ca, Ba, La, Ti, Zr, P, or Ta. The “positive electrode material layer disposed on at least one surface of the positive electrode current collector” means that the positive electrode material layer can be disposed on one surface of the positive electrode current collector in a thickness direction thereof, or on two surfaces of the positive electrode current collector in a thickness direction thereof. It should be noted that the “surface” herein may be an entire region or a partial region of the positive electrode current collector. This is not particularly limited in this application, provided that the objectives of this application can be achieved. In this application, the positive electrode active material substrate includes at least one of lithium cobalt oxide, lithium nickel cobalt manganese oxide (such as common NCM811, NCM622, NCM523, and NCM111), lithium manganese oxide, lithium iron phosphate, lithium manganese iron phosphate, or lithium-rich manganese-based material.

The particles of the positive electrode active material include a surface region and an internal region, wherein the surface region is a region from a surface of the particle to a depth of M nm inside the particle, 1≤M≤300, and the internal region is a region in the positive electrode active material other than the surface region. For example, M nm can be 1 nm, 2 nm, 5 nm, 10 nm, 15 nm, 20 nm, 25 nm, 30 nm, 35 nm, 40 nm, 45 nm, 50 nm, 100 nm, 150 nm, 200 nm, 250 nm, or 300 nm of the particles. The internal region is a region of the positive electrode active material other than the surface region. Based on a mass of the positive electrode active material, a weight percentage of any one of the second element in the surface region is 1000 ppm to 20000 ppm. For example, the weight percentage of any one of the second element in the surface region can be 1000 ppm, 2000 ppm, 3000 ppm, 4000 ppm, 5000 ppm, 6000 ppm, 7000 ppm, 8000 ppm, 9000 ppm, 10000 ppm, 11000 ppm, 12000 ppm, 13000 ppm, 14000 ppm, 15000 ppm, 16000 ppm, 17000 ppm, 18000 ppm, 19000 ppm, 20000 ppm, or in a range defined by any two of the above values. A weight percentage of any one of the second element in the internal region is less than 500 ppm. For example, the weight percentage of any one of the second element in the internal region can be 10 ppm, 50 ppm, 100 ppm, 150 ppm, 200 ppm, 250 ppm, 300 ppm, 350 ppm, 400 ppm, 450 ppm, 490 ppm, or in a range defined by any two of the above values.

The inventors have found that with the positive electrode active material including the positive electrode active material substrate and the solid electrolyte material, and with at least part of the solid electrolyte material disposed on the surface of the positive electrode active material substrate, first, lithium-ion conduction inside the positive electrode plate can be improved, reducing the impedance of the secondary battery and enhancing the kinetics of the secondary battery, thereby improving the cycling performance and rate performance of the secondary battery. Second, since the solid electrolyte material is present on the surface of the positive electrode active material substrate, side reactions between the positive electrode active material substrate and the electrolyte solution can be reduced, enhancing the stability of the positive electrode active material substrate, and reducing dissolution of transition metal from the positive electrode active material substrate, thereby improving the safety performance of the secondary battery. In this application, the weight percentage of any one of the second element in the surface region and the weight percentage of any one of the second element in the internal region being limited indicates that the solid electrolyte material is present in the surface region of the positive electrode active material and that the solid electrolyte material is basically absent in the internal region of the positive electrode active material. Controlling the positive electrode active material to include the positive electrode active material substrate and the solid electrolyte material, the positive electrode active material substrate to include the first element, the solid electrolyte material to include the second element, and the weight percentage of any one of the at least one second element in the surface region and the weight percentage of any one of the at least one second element in the internal region to fall within the ranges specified in this application can reduce the impedance of the secondary battery, and improve the rate performance, cycling performance, and safety performance of the secondary battery.

In an embodiment of this application, after the secondary battery goes through 100 cycles to 1500 cycles, based on a mass of the negative electrode material layer, a weight percentage W1 of any one of the first element is less than or equal to 1000 ppm. For example, the secondary battery can go through 100 cycles, 200 cycles, 300 cycles, 400 cycles, 500 cycles, 600 cycles, 700 cycles, 800 cycles, 900 cycles, 1000 cycles, 1100 cycles, 1200 cycles, 1300 cycles, 1400 cycles, or 1500 cycles. The weight percentage W1 of any one of the first element can be 100 ppm, 200 ppm, 300 ppm, 400 ppm, 500 ppm, 600 ppm, 700 ppm, 800 ppm, 900 ppm, 1000 ppm, or in a range defined by any two of the above values.

In an embodiment of this application, based on a mass of the positive electrode material layer, a weight percentage W2 of the solid electrolyte material is 0.2% to 10%. For example, W2 can be 0.2%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, or in a range defined by any two of the above values. Controlling the weight percentage W2 of the solid electrolyte material to fall within the range specified in this application can allow the solid electrolyte material on the surface of the positive electrode active material substrate to have an appropriate thickness, thereby further enhancing the stability of the positive electrode active material substrate, improving the safety performance of the secondary battery, reducing the impedance of the secondary battery, and improving the cycling performance and rate performance of the secondary battery.

In an embodiment of this application, a scanning electron microscope and energy spectrum analyzer is used to perform line scan on the particles of the positive electrode active material in a cross-section of the positive electrode material layer. The line scan includes three straight lines, the three straight lines intersect each other at an angle of 60°, and each straight line is 20 μm to 100 μm in length. For example, each straight line can be 20 μm, 30 μm, 40 μm, 50 μm, 60 μm, 70 μm, 80 μm, 90 μm, 100 μm, or in a range defined by any two of the above values. In a line scan spectrum of at least any two straight lines, there are x first peaks of any one of the first element, there are y second peaks of any one of the second element, with y=2x, and a peak top region of the first peak corresponds to a peak top region of the second peak. The line scan spectrum meeting the above characteristic indicates that the solid electrolyte material is present on the surface of the positive electrode active material substrate and that the solid electrolyte material is uniformly distributed on the surface of the positive electrode active material substrate. This can improve lithium-ion conduction inside the positive electrode plate, reduce side reactions between the positive electrode active material and the electrolyte solution, and improve the cycling performance, rate performance, and safety performance of the secondary battery.

In an embodiment of this application, the positive electrode material layer includes at least one of Al, La, Ti, or Zr. This can further reduce the impedance of the secondary battery, and further enhance the cycling performance, rate performance, and safety performance of the secondary battery.

In an embodiment of this application, the positive electrode material layer includes Al, and based on the mass of the positive electrode material layer, a weight percentage W3 of Al is 42 ppm to 3000 ppm, and preferably W3 is 211 ppm to 2110 ppm. For example, the weight percentage W3 of Al can be 42 ppm, 72 ppm, 100 ppm, 211 ppm, 300 ppm, 500 ppm, 700 ppm, 900 ppm, 1000 ppm, 1500 ppm, 2000 ppm, 2110 ppm, 2500 ppm, 3000 ppm, or in a range defined by any two of the above values. The positive electrode material layer includes Al, and the weight percentage W3 of Al is within the range specified in this application, meaning that Al in the positive electrode material layer has an appropriate weight percentage. This indicates that an appropriate amount of solid electrolyte material is dispersed on the surface of the positive electrode active material substrate, further reducing the impedance of the secondary battery and improving the cycling performance of the secondary battery.

In an embodiment of this application, the positive electrode material layer includes La, and based on the mass of the positive electrode material layer, a weight percentage W4 of La is 1600 ppm to 50000 ppm. For example, the weight percentage W4 of La can be 1600 ppm, 1800 ppm, 2000 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, 8500 ppm, 9000 ppm, 9500 ppm, 10000 ppm, 20000 ppm, 30000 ppm, 40000 ppm, 50000 ppm, or in a range defined by any two of the above values. The positive electrode material layer includes La, and the weight percentage W4 of La is within the range specified in this application, meaning that La in the positive electrode material layer has an appropriate weight percentage. This indicates that an appropriate amount of solid electrolyte material is dispersed on the surface of the positive electrode active material substrate, improving lithium-ion conduction inside the positive electrode plate. In addition, due to its catalytic activity, La can catalyze the polymerization of the electrolyte solution, and the resulting polymer after polymerization covers the surface of the positive electrode active material, improving the reactivity between the positive electrode active material and the electrolyte solution. This can further reduce the impedance of the secondary battery and improve the cycling performance of the secondary battery.

In an embodiment of this application, the positive electrode material layer includes Ti, and based on the mass of the positive electrode material layer, a weight percentage W5 of Ti is 425 ppm to 35000 ppm, and preferably W5 is 2126 ppm to 21261 ppm. For example, the weight percentage W5 of Ti can be 425 ppm, 800 ppm, 1600 ppm, 1800 ppm, 2000 ppm, 2126 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, 8500 ppm, 9000 ppm, 9500 ppm, 10000 ppm, 20000 ppm, 21261 ppm, 30000 ppm, 35000 ppm, or in a range defined by any two of the above values. The positive electrode material layer includes Ti, and the weight percentage W5 of Ti is within the range specified in this application, meaning that Ti in the positive electrode material layer has an appropriate weight percentage. This indicates that an appropriate amount of solid electrolyte material is dispersed on the surface of the positive electrode active material substrate, improving lithium-ion conduction inside the positive electrode plate. In addition, due to its catalytic activity, Ti can catalyze the polymerization of the electrolyte solution, and the resulting polymer after polymerization covers the surface of the positive electrode active material, improving the reactivity between the positive electrode active material and the electrolyte solution. This can further reduce the impedance of the secondary battery and improve the cycling performance of the secondary battery.

In an embodiment of this application, the positive electrode material layer includes Zr, and based on the mass of the positive electrode material layer, a weight percentage W6 of Zr is 720 ppm to 25000 ppm. For example, the weight percentage W6 of Zr can be 720 ppm, 800 ppm, 1600 ppm, 1800 ppm, 2000 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, 8500 ppm, 9000 ppm, 9500 ppm, 10000 ppm, 20000 ppm, 25000 ppm, or in a range defined by any two of the above values. The positive electrode material layer includes Zr, and the weight percentage W6 of Zr is within the range specified in this application, meaning that Zr in the positive electrode material layer has an appropriate weight percentage. This indicates that an appropriate amount of solid electrolyte material is dispersed on the surface of the positive electrode active material substrate, improving lithium-ion conduction inside the positive electrode plate. In addition, due to its catalytic activity, Zr can catalyze the polymerization of the electrolyte solution, and the resulting polymer after polymerization covers the surface of the positive electrode active material, improving the reactivity between the positive electrode active material and the electrolyte solution. This can further reduce the impedance of the secondary battery and improve the cycling performance of the secondary battery.

In an embodiment of this application, an average particle size of the positive electrode active material is 5 μm to 30 μm, and preferably the average particle size of the positive electrode active material is 8 μm to 20 μm. For example, the average particle size of the positive electrode active material can be 5 μm, 6 μm, 8 μm, 10 μm, 12 μm, 14 μm, 16 μm, 18 μm, 20 μm, 22 μm, 24 μm, 26 μm, 28 μm, 30 μm, or in a range defined by any two of the above values. Controlling the average particle size of the positive electrode active material to fall within the range specified in this application can allow the positive electrode active material to have an appropriate average particle size, further improving lithium-ion conduction inside the positive electrode plate, further reducing the impedance of the secondary battery, enhancing the kinetics of the secondary battery, and further improving the cycling performance and rate performance of the secondary battery.

In an embodiment of this application, a specific surface area B of the positive electrode active material is 0.2 m²/g to 0.8 m²/g, and preferably the specific surface area B of the positive electrode active material is 0.28 m²/g to 0.41 m²/g. For example, the specific surface area B of the positive electrode active material can be 0.2 m²/g, 0.22 m²/g, 0.25 m²/g, 0.28 m²/g, 0.3 m²/g, 0.32 m²/g, 0.35 m²/g, 0.37 m²/g, 0.4 m²/g, 0.41 m²/g, 0.45 m²/g, 0.47 m²/g, 0.5 m²/g, 0.52 m²/g, 0.55 m²/g, 0.57 m²/g, 0.6 m²/g, 0.62 m²/g, 0.65 m²/g, 0.67 m²/g, 0.7 m²/g, 0.72 m²/g, 0.75 m²/g, 0.77 m²/g, 0.8 m²/g, or in a range defined by any two of the above values. Controlling the specific surface area B of the positive electrode active material to fall within the range specified in this application can allow the positive electrode active material to have an appropriate specific surface area, further improving lithium-ion conduction inside the positive electrode plate, further reducing the impedance of the secondary battery, enhancing the kinetics of the secondary battery, and further improving the cycling performance and rate performance of the secondary battery.

In an embodiment of this application, the porosity of the positive electrode plate is 18% to 30%. For example, the porosity of the positive electrode plate can be 18%, 19%, 20%, 21%, 22%, 23%, 24%, 25%, 26%, 27%, 28%, 29%, 30%, or in a range defined by any two of the above values. Controlling the porosity of the positive electrode plate to fall within the range specified in this application can allow the positive electrode plate to have an appropriate porosity, so that the secondary battery has low impedance, good rate performance, good cycling performance, and good safety performance while also having relatively high energy density.

In an embodiment of this application, the solid electrolyte material includes at least one selected from the group consisting of the following compounds and the following compounds with a doping element: NASICON-structured Li₁₊ₓ₁Alₓ₁Ge₂₋ₓ₁(PO₄)₃, NASICON-structured Li₁₊ₓ₂Alₓ₂Ti₂₋ₓ₂(PO₄)₃, perovskite-structured Li₃ₓ₃La_{2/3-x3}TiO₃, perovskite-structured Li_{3/8}Sr_{7/16}Ta_{3/4}Hf_{1/4}O₃, perovskite-structured Li_{2x4-y1}Sr₁₋ₓ₄Ta_{y1}Zr_{1-y1}O₃, anti-perovskite-structured Li₃₋₂ₓ₅Mₓ₅HalO, anti-perovskite-structured Li₃OCl, LISICON-structured Li₄₋ₓ₆Si₁₋ₓ₆Pₓ₆O₄, LISICON-structured Li₁₄ZnGe₄O₁₆, and garnet-structured Li₇₋ₓ₇La₃Zr₂₋ₓ₇O₁₂, where 0<x1≤0.75, 0<x2≤0.5, 0.1≤x3≤0.3, 0.25≤y1≤1, x4=0.75y1, 0≤x5≤0.01, 0.5≤x6≤0.6, and 0≤x7≤1. For example, x1 can be 0.15, 0.25, 0.35, 0.45, 0.55, 0.65, 0.75, or in a range defined by any two of the above values; x2 can be 0.05, 0.1, 0.15, 0.2, 0.25, 0.3, 0.35, 0.4, 0.45, 0.5, or in a range defined by any two of the above values; x3 can be 0.1, 0.12, 0.14, 0.16, 0.18, 0.2, 0.22, 0.24, 0.26, 0.28, 0.3, or in a range defined by any two of the above values; y1 can be 0.25, 0.3, 0.4, 0.5, 0.6, 0.7, 0.8, 0.9, 1, or in a range defined by any two of the above values; x5 can be 0, 0.001, 0.002, 0.003, 0.004, 0.005, 0.006, 0.007, 0.008, 0.009, 0.01, or in a range defined by any two of the above values; x6 can be 0.5, 0.51, 0.52, 0.53, 0.54, 0.55, 0.56, 0.57, 0.58, 0.59, 0.6, or in a range defined by any two of the above values; and x7 can be 0, 0.1, 0.2, 0.3, 0.4, 0.5, 0.6, 0.7, 0.8, 0.9, or in a range defined by any two of the above values. M includes at least one of Mg, Ca, Sr, or Ba, and Hal includes at least one of Cl or I; and the doping element includes at least one of Sn, Si, Ge, Sr, Ta, or Ce. Selecting the above solid electrolyte material can further improve lithium-ion conduction inside the positive electrode plate, further reduce the impedance of the secondary battery, enhancing the kinetics of the secondary battery, and further improve the cycling performance and rate performance of the secondary battery. This application does not particularly limit the weight percentage of the doping element as long as the objectives of this application can be achieved. For example, based on a mass of the solid electrolyte material, a weight percentage of the doping element is 0.1% to 0.5%.

In an embodiment of this application, the ionic conductivity of the solid electrolyte material is 8×10⁻⁵ S/cm to 1×10⁻³ S/cm. For example, the ionic conductivity of the solid electrolyte material can be 8×10⁻⁵ S/cm, 9×10⁻⁵ S/cm, 1×10⁻⁴ S/cm, 2×10⁻⁴ S/cm, 3×10⁻⁴ S/cm, 4×10⁻⁴ S/cm, 5×10⁻⁴ S/cm, 6×10⁻⁴ S/cm, 7×10⁻⁴ S/cm, 8×10⁻⁴ S/cm, 9×10⁻⁴ S/cm, 1×10⁻³ S/cm, or in a range defined by any two of the above values. The electronic conductivity of the solid electrolyte material is 1×10⁻¹⁴ S/cm to 1×10⁻⁸ S/cm. For example, the electronic conductivity of the solid electrolyte material is 1×10⁻¹⁴ S/cm, 1×10⁻¹³ S/cm, 1×10⁻¹² S/cm, 1×10⁻¹¹ S/cm, 1×10⁻¹⁰ S/cm, 1×10⁻⁹ S/cm, 1×10⁻⁸ S/cm, or in a range defined by any two of the above values. The ionic conductivity and electronic conductivity of the solid electrolyte material falling within the ranges specified in this application can accelerate lithium-ion conduction inside the positive electrode plate, further reduce the impedance of the secondary battery, and improve the kinetics of the secondary battery, thereby further enhancing the cycling performance and rate performance of the secondary battery.

In an embodiment of this application, the electrolyte solution includes a lithium salt, the lithium salt includes a first fluorine-containing lithium salt and/or a second fluorine-containing lithium salt, the first fluorine-containing lithium salt includes lithium hexafluorophosphate, and the second fluorine-containing lithium salt includes one of lithium bis(fluorosulfonyl)imide, lithium bis(trifluoromethylsulfonyl)imide, lithium tetrafluoroborate, lithium difluorooxalate borate, lithium bis(oxalate)borate, or lithium difluorophosphate; where based on a mass of the electrolyte solution, a weight percentage A1 of the first fluorine-containing lithium salt is 4.6% to 22.09%. For example, the weight percentage A1 of the first fluorine-containing lithium salt can be 4.6%, 5%, 6%, 7%, 8%, 9%, 10%, 11%, 12%, 13%, 14%, 15%, 16%, 17%, 18%, 19%, 20%, 21%, 22.09%, or in a range defined by any two of the above values. A weight percentage A2 of the second fluorine-containing lithium salt is 0.46% to 11.1%. For example, the weight percentage A2 of the second fluorine-containing lithium salt can be 0.46%, 0.5%, 0.8%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11.1%, or in a range defined by any two of the above values. Controlling the lithium salt in the electrolyte solution to include the first fluorine-containing lithium salt and/or the second fluorine-containing lithium salt, the types and proportions of the first fluorine-containing lithium salt and second fluorine-containing lithium salt to fall within the ranges specified in this application can allow a solid electrolyte material interphase (SEI) film formed on the surface of the negative electrode plate to have appropriate weight percentages of Li and F. This can increase the inorganic proportion in the SEI film and improve the ionic conduction of the SEI film, thereby further enhancing the cycling performance and rate performance of the secondary battery.

In an embodiment of this application, based on a mass of the negative electrode material layer, a weight percentage W7 of the first element is 0.01% to 0.1%. For example, the weight percentage W7 of the first element can be 0.01%, 0.02%, 0.03%, 0.04%, 0.05%, 0.06%, 0.07%, 0.08%, 0.09%, 0.1%, or in a range defined by any two of the above values. 4.6×10⁻⁷≤A2×W7≤1.11×10⁻⁴. For example, the value of A2×W7 can be 4.6×10⁻⁷, 5×10⁻⁷, 1×10⁻⁶, 5×10⁻⁶, 1×10⁻⁵, 5×10⁻⁵, 1.11×10⁻⁴, or in a range defined by any two of the above values. Controlling the weight percentage W7 of the first element and the value of A2×W7 to fall within the ranges specified in this application can allow the weight percentage A2 of the second fluorine-containing lithium salt to match with the weight percentage W7 of the first element, and the electrolyte solution to synergize with the positive electrode active material. This reduces dissolution of transition metal from the positive electrode active material substrate, and further improves the safety performance of the secondary battery. The weight percentage W7 of the first element refers to that after the secondary battery is subjected to 100 cycles to 1500 cycles, the weight percentage of the first element is W7 based on the mass of the negative electrode material layer.

This application does not particularly limit the preparation method of the positive electrode active material as long as the objectives of this application can be achieved. For example, the preparation method of the positive electrode active material including Li₁₊ₓ₂Alₓ₂Ti₂₋ₓ₂(PO₄)₃ may include the following steps: according to the chemical formula of the required solid electrolyte material, mixing AlPO₄, Ti₃(PO₄)₄, and Li₃PO₄ in a certain mass ratio, and then adding the positive electrode active material substrate for mixing to obtain a mixture. The above mixture was sintered at high temperature to obtain a positive electrode active material. This application does not particularly limit the mixing manner as long as the objectives of this application can be achieved. For example, the mixing manner can be ball milling. This application does not particularly limit the high-temperature sintering as long as the objectives of this application can be achieved. For example, high-temperature sintering can be done in an air furnace, the temperature of the high-temperature sintering can be 700° C. to 1000° C., and the sintering time of the high-temperature sintering can be 2 h to 8 h. In this application, preparing the positive electrode active material using the above preparation method can make the solid electrolyte material form in situ on the surface of the positive electrode active material substrate.

For example, the preparation method of the positive electrode active material including Li₇₋ₓ₇La₃Zr₂₋ₓ₇O₁₂ may include the following steps: according to the chemical formula of the required solid electrolyte material, mixing lithium carbonate, lanthanum oxide, and zirconium oxide in a certain mass ratio, and then adding the positive electrode active material substrate for mixing to obtain a mixture. The above mixture was sintered at high temperature to obtain a positive electrode active material. This application does not particularly limit the mixing manner as long as the objectives of this application can be achieved. For example, the mixing manner can be ball milling. This application does not particularly limit the high-temperature sintering as long as the objectives of this application can be achieved. For example, high-temperature sintering can be done in an air furnace, the temperature of the high-temperature sintering can be 800° C. to 1500° C., and the sintering time of the high-temperature sintering can be 2 h to 8 h.

For example, the preparation method of the positive electrode active material including Li₃ₓ₃La_{2/3-x3}TiO₃ may include the following steps: according to the chemical formula of the required solid electrolyte material, mixing lithium carbonate, lanthanum oxide, and titanium dioxide in a certain mass ratio, and then adding the positive electrode active material substrate for mixing to obtain a mixture. The above mixture was sintered at high temperature to obtain a positive electrode active material. This application does not particularly limit the mixing manner as long as the objectives of this application can be achieved. For example, the mixing manner can be ball milling. This application does not particularly limit the high-temperature sintering as long as the objectives of this application can be achieved. For example, high-temperature sintering can be done in an air furnace, the temperature of the high-temperature sintering can be 800° C. to 1500° C., and the sintering time of the high-temperature sintering can be 2 h to 8 h.

In this application, the solid electrolyte material further includes a compound containing a doping element. The doping element includes at least one of Sn, Si, Ge, Sr, Ta, or Ce. When the prepared positive electrode active material includes a solid electrolyte material that is a compound containing a doping element, a compound containing the corresponding doping element is added to the reaction raw materials to prepare the positive electrode active material. This application does not particularly limit the compound containing a doping element as long as the objectives of this application can be achieved. For example, the compound containing a doping element may include at least one of tin chloride, silicon chloride, germanium chloride, strontium chloride, tantalum chloride, or cerium oxide.

This application does not particularly limit the method of controlling the weight percentage of any one of the second element in the surface region or internal region as long as the objectives of this application can be achieved. For example, the weight percentage of any one of the second element in the surface region or internal region can be controlled by controlling the mass ratio of the solid electrolyte material raw materials added to the mass of the positive electrode active material substrate.

This application does not particularly limit the method of controlling the weight percentage W2 of the solid electrolyte material, the weight percentage W3 of A1, the weight percentage W4 of La, the weight percentage W5 of Ti, or the weight percentage W6 of Zr as long as the objectives of this application can be achieved. For example, the weight percentage W2 of the solid electrolyte material, the weight percentage W3 of Al, the weight percentage W4 of La, the weight percentage W5 of Ti, or the weight percentage W6 of Zr can be controlled by controlling the type and weight percentage of the solid electrolyte material added.

This application does not particularly limit the method of controlling the weight percentage W7 of the first element as long as the objectives of this application can be achieved. For example, the weight percentage W7 of the first element can be controlled by controlling the type and weight percentage of the positive electrode active material substrate added.

This application does not particularly limit the methods for controlling the average particle size and specific surface area B of the positive electrode active material as long as the objectives of this application can be achieved. For example, the average particle size and specific surface area B of the positive electrode active material can be controlled by grinding the positive electrode active material. For example, the average particle size and specific surface area B of the positive electrode active material can be controlled by controlling the grinding time. For example, under the same conditions, extending the grinding time reduces the average particle size of the positive electrode active material and increases the specific surface area; and shortening the grinding time increases the average particle size of the positive electrode active material and reduces the specific surface area.

This application does not particularly limit the method of controlling the porosity of the positive electrode plate as long as the objectives of this application can be achieved. For example, the porosity of the positive electrode plate can be controlled by controlling the cold pressing pressure during cold pressing. For example, under the same conditions, increasing the cold pressing pressure reduces the porosity, and reducing the cold pressing pressure increases the porosity.

This application does not particularly limit the positive electrode current collector as long as the objectives of this application can be achieved. For example, aluminum foil, aluminum alloy foil, a composite current collector (for example, aluminum-carbon composite current collector), or the like can be included.

The positive electrode material layer of this application further includes a conductive agent and a binder. This application does not particularly limit the conductive agent as long as the objectives of this application can be achieved. For example, the conductive agent may include but is not limited to at least one of conductive carbon black, carbon nanotubes (CNTs), carbon fiber, flake graphite, graphene, metal material, or conductive polymer. The above conductive carbon black may include but is not limited to acetylene black and/or Ketjen black. The carbon nanotubes may include but are not limited to single-walled carbon nanotubes and/or multi-walled carbon nanotubes. The carbon fibers may include but are not limited to vapor grown carbon fibers (VGCF) and/or carbon nanofibers. The metal material may include but is not limited to metal powder and/or metal fiber, and specifically, the metal may include but is not limited to at least one of copper, nickel, aluminum, or silver. The conductive polymer may include but is not limited to at least one of a polyphenylene derivative, polyaniline, polythiophene, polyacetylene, or polypyrrole. This application does not particularly limit the binder as long as the objectives of this application can be achieved. For example, the binder may include but is not limited to at least one of polyacrylate, polyimide, polyamide, polyamide-imide, polyvinylidene fluoride (PVDF), styrene-butadiene copolymer (styrene-butadiene rubber), sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose. This application does not particularly limit the mass ratio of the positive electrode active material, conductive agent, and binder in the positive electrode material layer. Persons skilled in the art can make a selection based on actual needs as long as the objectives of this application can be achieved.

This application does not particularly limit the thickness of the positive electrode current collector as long as the objectives of this application can be achieved. For example, the thickness of the positive electrode current collector is 5 μm to 20 μm. This application does not particularly limit the thickness of the positive electrode material layer as long as the objectives of this application can be achieved. For example, the thickness of the positive electrode material layer is 15 μm to 250 μm. This application does not particularly limit the thickness of the positive electrode plate as long as the objectives of this application can be achieved. For example, the thickness of the positive electrode plate is 20 μm to 250 μm.

Optionally, the positive electrode plate may further include a conductive layer, and the conductive layer is sandwiched between the positive electrode current collector and the positive electrode material layer. This application does not particularly limit the composition of the conductive layer, and it can be a commonly used conductive layer in the field. The conductive layer includes a conductive agent and a binder. This application does not particularly limit the conductive agent and binder in the conductive layer. They can be at least one of the foregoing conductive agents and binders. This application does not particularly limit the mass ratio of the conductive agent and binder in the conductive layer. Persons skilled in the art can make a selection based on actual needs as long as the objectives of this application can be achieved.

In this application, the electrolyte solution further includes a non-aqueous solvent. The non-aqueous solvent is not particularly limited in this application, provided that the objectives of this application can be achieved. For example, the non-aqueous solvent may include but is not limited to at least one of carbonate compound, carboxylate compound, ether compound, or another organic solvent. The carbonate compound may include but is not limited to at least one of a linear carbonate compound, a cyclic carbonate compound, or a fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethylene propyl carbonate (EPC), or methyl ethyl carbonate (MEC). The cyclic carbonate compound may include but is not limited to at least one of ethylene carbonate (EC), propylene carbonate (PC), butylene carbonate (BC), or vinyl ethylene carbonate (VEC). The fluorocarbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of dibutyl ether, tetraethylene glycol dimethyl ether, diglyme, 1,2-dimethoxyethane, 1,2-diethoxyethane, 1-ethoxy-1-methoxyethane, 2-methyltetrahydrofuran, or tetrahydrofuran. The another organic solvent may include but is not limited to at least one of dimethyl sulfoxide, 1,2-dioxolane, sulfolane, methyl-sulfolane, 1,3-dimethyl-2-imidazolidinone, N-methyl-2-pyrrolidone, dimethylformamide, acetonitrile, trimethyl phosphate, triethyl phosphate, or trioctyl phosphate. Based on the mass of the electrolyte solution, the weight percentage of the non-aqueous solvent is 66.81% to 95.4%.

In an embodiment of this application, the electrolyte solution includes a lithium salt, where the lithium salt includes a first fluorine-containing lithium salt, and the first fluorine-containing lithium salt includes lithium hexafluorophosphate. The electrolyte solution further includes a non-aqueous solvent. When the lithium salt includes the first fluorine-containing lithium salt, this application does not particularly limit the weight percentage of the first fluorine-containing lithium salt and the non-aqueous solvent as long as the objectives of this application can be achieved. For example, based on the mass of the electrolyte solution, the weight percentage A1 of the first fluorine-containing lithium salt can be 4.6% to 22.09%, and the weight percentage of the non-aqueous solvent can be 77.91% to 95.4%.

This application does not particularly limit the method of controlling the value of A2×W7 as long as the objectives of this application can be achieved. For example, the value of A2×W7 can be controlled by controlling the respective values of A2 and W7. The method of controlling the value of W7 is as described above.

In this application, the negative electrode plate includes a negative electrode current collector and a negative electrode material layer disposed on at least one surface of the negative electrode current collector. The “negative electrode material layer disposed on at least one surface of the negative electrode current collector” means that the negative electrode material layer can be disposed on one surface of the negative electrode current collector in a thickness direction thereof, or on two surfaces of the negative electrode current collector in a thickness direction thereof. It should be noted that the “surface” herein may be an entire region of the negative electrode current collector, or may be a partial region of the positive electrode current collector. This is not particularly limited in this application, provided that the objectives of this application can be achieved. The negative electrode current collector is not particularly limited in this application provided that it can achieve the objectives of this application. For example, it may include copper foil, copper alloy foil, nickel foil, stainless steel foil, titanium foil, foamed nickel, foamed copper, a composite current collector, or the like.

The negative electrode material layer of this application includes a negative electrode active material. This application does not particularly limit the negative electrode active material as long as the objectives of this application can be achieved. For example, the negative electrode active material in this application may include at least one of natural graphite, artificial graphite, a mesocarbon microbead (MCMB), hard carbon, soft carbon, silicon, a silicon-carbon composite, SiOₓ (0.5<x<1.6), a Li—Sn alloy, a Li—Sn—O alloy, Sn, SnO, SnO₂, spinel-structure lithium titanate Li₄Ti₅O₁₂, a Li—Al alloy, lithium metal, or the like. The negative electrode material layer of this application further includes a binder and a conductive agent. This application does not particularly limit the binder and conductive agent in the negative electrode material layer as long as the objectives of this application can be achieved. For example, the binder can be at least one of the foregoing binders, and the conductive agent can be at least one of the foregoing conductive agents. The negative electrode material layer of this application further includes a dispersant. This application does not particularly limit the dispersant in the negative electrode material layer as long as the objectives of this application can be achieved. For example, the dispersant may include sodium carboxymethyl cellulose (CMC-Na). This application does not particularly limit the mass ratio of the negative electrode active material, binder, conductive agent, and dispersant in the negative electrode material layer. Persons skilled in the art can make a selection based on actual needs as long as the objectives of this application can be achieved.

This application does not particularly limit the thickness of the negative electrode current collector as long as the objectives of this application can be achieved. For example, the thickness of the negative electrode current collector is 4 μm to 12 μm. This application does not particularly limit the thickness of the negative electrode material layer as long as the objectives of this application can be achieved. For example, the thickness of the negative electrode material layer is 30 μm to 250 μm. This application does not particularly limit the thickness of the negative electrode plate as long as the objectives of this application can be achieved. For example, the thickness of the negative electrode plate is 30 μm to 250 μm.

Optionally, the negative electrode plate may further include a conductive layer, and the conductive layer is sandwiched between the negative electrode current collector and the negative electrode material layer. This application does not particularly limit the composition of the conductive layer, and it can be a commonly used conductive layer in the field. The conductive layer includes a conductive agent and a binder. This application does not particularly limit the conductive agent and binder in the conductive layer. They can be at least one of the foregoing conductive agents and binders. This application does not particularly limit the mass ratio of the conductive agent and binder in the conductive layer. Persons skilled in the art can make a selection based on actual needs as long as the objectives of this application can be achieved.

In this application, the secondary battery further includes a separator. The separator is used to separate the positive electrode plate and the negative electrode plate, prevent internal short circuits in the secondary battery, and allow electrolyte ions to pass freely without affecting the electrochemical charge and discharge process. This application does not particularly limit the separator as long as the objectives of this application can be achieved. For example, the material of the separator may include but is not limited to at least one of polyolefins (PO) mainly composed of polyethylene (PE) and polypropylene (PP), polyester (for example, polyethylene terephthalate (PET) film), cellulose, polyimide (PI), polyamide (PA), spandex, or aramid. The type of the separator may include at least one of woven film, non-woven film, microporous film, composite film, calendered film, or spun film.

In this application, the separator may include a substrate layer and a surface treatment layer. The substrate may be a non-woven fabric or composite film of a porous structure. The substrate may be made of at least one of polyethylene, polypropylene, polyethylene terephthalate, or polyimide. Optionally, a polypropylene porous film, a polyethylene porous film, polypropylene non-woven fabric, polyethylene non-woven fabric, or a polypropylene-polyethylene-polypropylene porous composite film may be used. Optionally, the surface treatment layer is provided on at least one surface of the substrate layer, and the surface treatment layer may be a polymer layer or an inorganic substance layer, or a layer formed by a mixture of a polymer and an inorganic substance. For example, the inorganic substance layer includes inorganic particles and a binder. This application does not particularly limit the inorganic particles, and for example, may include at least one of aluminum oxide, silicon oxide, magnesium oxide, titanium oxide, hafnium dioxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. This application does not particularly limit the above-mentioned binder. For example, the binder can be at least one of the foregoing binders. The polymer layer contains a polymer, and the polymer is made of at least one of polyamide, polyacrylonitrile, an acrylate polymer, polyacrylic acid, polyvinylpyrrolidone, polyvinyl ether, polyvinylidene fluoride, or poly(vinylidene fluoride-hexafluoropropylene).

The secondary battery of this application further includes a packaging bag for accommodating the positive electrode plate, the separator, the negative electrode plate, and the electrolyte solution, as well as other components known in the field of secondary batteries. This application does not limit the foregoing other components. This application does not particularly limit the packaging bag which can be any packaging bag well known in the field as long as the objectives of this application can be achieved.

In this application, the secondary battery may include but is not limited to a lithium metal secondary battery, a lithium-ion secondary battery (lithium-ion battery), a lithium polymer secondary battery, a lithium-ion polymer secondary battery, or the like.

A preparation process of the secondary battery is well known to persons skilled in the art, and is not particularly limited in this application. For example, the preparation process may include but is not limited to the following steps: a positive electrode plate, a separator, and a negative electrode plate are stacked in sequence and go through operations such as winding and folding as needed to obtain an electrode assembly with a winding structure, the electrode assembly is put into a packaging bag, and the packaging bag is injected with an electrolyte solution and sealed to obtain a secondary battery. Alternatively, a positive electrode plate, a separator, and a negative electrode plate are stacked in sequence, four corners of the entire laminated structure are fixed with tapes to obtain an electrode assembly with a laminated structure, the electrode assembly is put into a packaging bag, and the packaging bag is injected with an electrolyte solution and sealed to obtain a secondary battery. In addition, an over-current protection element, a guide, and the like may also be placed into the packaging bag as needed, so as to prevent pressure increase, overcharge, and discharge inside the secondary battery. The packaging bag is a packaging bag known in the field and is not limited in this application.

A second aspect of this application provides an electronic apparatus including the secondary battery according to any one of the foregoing embodiments. Therefore, the electronic apparatus provided in this application has good usage performance.

The type of the electronic apparatus in this application is not particularly limited, and may be any known electronic apparatus used in the prior art. In some embodiments, the electronic apparatus may include but is not limited to notebook computers, pen-input computers, mobile computers, electronic book players, portable telephones, portable fax machines, portable copiers, portable printers, stereo headsets, video recorders, liquid crystal display televisions, portable cleaners, portable CD players, mini-disc players, transceivers, electronic notebooks, calculators, storage cards, portable recorders, radios, backup power sources, motors, automobiles, motorcycles, motor bicycles, bicycles, lighting appliances, toys, game machines, clocks, electric tools, flash lamps, cameras, large household batteries, lithium-ion capacitors, and the like.

### EXAMPLES

The following describes the embodiments of this application more specifically by using examples and comparative examples. Various tests and evaluations are performed in the following methods. In addition, unless otherwise specified, “part” and “%” are based on weight.

### Test Method and Device

### Test for Weight Percentage of Second Element in Surface Region and Internal Region

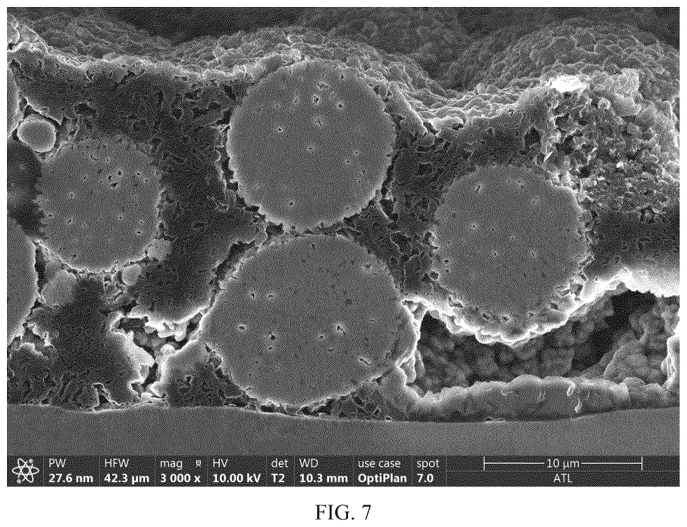

The lithium-ion battery was discharged to 3.0 V, and disassembled to obtain the positive electrode plate. The positive electrode plate was soaked and washed with DMC for 8 h. The washed positive electrode plate was taken out and dried in a vacuum drying oven for 14 h. The positive electrode material layer was scrapped with a blade, the scraped-off powder of the positive electrode material layer was subjected to sonic dispersion to obtain the particles of the positive electrode material layer. A Philips XL-30 field emission scanning electron microscope and energy spectrum analyzer was used to observe the cross-section of the particles of the positive electrode material layer. As shown in FIG. 7, the larger particles are particles of the positive electrode active material, the interface between the black and white contrast of the particles is the surface region, and the whiter region of the contrast of the particles is the internal region. Then, under the conditions of 10 kV and 10 mA, a measuring tool was used to test the weight percentage of the second element in the region from the surface of the particles to an internal location with a depth of 1 nm to 300 nm of the particles, which was the weight percentage of the second element in the surface region. The measuring tool was used to test the weight percentage of the second element in a region other than the surface region, which was the weight percentage of the second element in the internal region.

### Test for Weight Percentage of First Element after 500 Cycles of Lithium-Ion Battery

Under the condition of 25° C., the lithium-ion battery was charged to 4.45 V at a constant current of 0.5 C rate, then charged at a constant voltage of 4.45 V until the current was 0.025 C, left standing for 5 min, and then discharged at a constant current of 0.5 C rate to 3.0 V. This was one charge-discharge cycle. The above process was repeated for 500 charge-discharge cycles. Then the lithium-ion battery was charged to 4.45 V at a constant current of 0.5 C rate, then charged at a constant voltage of 4.45 V until the current was 0.025 C. At this point, the lithium-ion battery was fully charged. The lithium-ion battery was disassembled to obtain the negative electrode plate, and the negative electrode material layer was scrapped with a blade to obtain the powder of the negative electrode material layer.

The weight percentage of the first element was tested using an inductively coupled plasma optical emission spectrometer (ICP-OES). 3 g powder of the negative electrode material layer was dissolved in 30 mL aqua regia (obtained by mixing concentrated hydrochloric acid with a concentration of 36% and concentrated nitric acid with a concentration of 65% in a volume ratio of 3:1) for digestion. The digested solution was injected into an inductively coupled plasma optical emission spectrometer (model: Thermo Fisher iCAP PRO XP ICP-OES) for testing to obtain the weight percentage of the first element.

### Test for Weight Percentage of Solid Electrolyte Material

The lithium-ion battery was discharged to 3.0 V and disassembled to obtain the positive electrode plate, and the positive electrode material layer was scrapped with a blade to obtain the powder of the positive electrode material layer. An inductively coupled plasma optical emission spectrometer (ICP-OES) was used for testing. 3 g powder of the positive electrode material layer was dissolved in 30 mL aqua regia (obtained by mixing concentrated hydrochloric acid with a concentration of 36% and concentrated nitric acid with a concentration of 65% in a volume ratio of 3:1) for digestion. The digested solution was injected into an inductively coupled plasma optical emission spectrometer (model: Thermo Fisher iCAP PRO XP ICP-OES) for testing. The test spectrum could be compared with the standard spectrum to obtain the corresponding element content of the solid electrolyte material. The weight percentage of the solid electrolyte material can be calculated from the element proportion.

### Line Scan Test

A scanning electron microscope and energy spectrum analyzer was used to perform line scan on the particles of the positive electrode active material in a cross-section of the positive electrode material layer. The line scan includes three straight lines, and the three straight lines intersect each other at an angle of 60°. Test was performed to obtain the line scan spectra of the three straight lines.

### Test for Weight Percentage of Element in Positive Electrode Material Layer

The lithium-ion battery was discharged to 3.0 V and disassembled to obtain the positive electrode plate, and the positive electrode material layer was scrapped with a blade to obtain the powder of the positive electrode material layer. An inductively coupled plasma optical emission spectrometer (ICP-OES) was used for testing. 3 g powder of the positive electrode material layer was dissolved in 30 mL aqua regia (obtained by mixing concentrated hydrochloric acid with a concentration of 36% and concentrated nitric acid with a concentration of 65% in a volume ratio of 3:1) for digestion. The digested solution was injected into an inductively coupled plasma optical emission spectrometer (model: Thermo Fisher iCAP PRO XP ICP-OES) for testing to obtain the weight percentage of the element in the positive electrode material layer.

### Test for Average Particle Size

The lithium-ion battery was discharged to 3.0 V for disassembly to take out the positive electrode plate. A cross-section polisher (model: IB-09010CP) was used to cut and polish the positive electrode plate with a high-energy ion beam. The obtained cross-section sample was placed under a scanning electron microscope (SEM) for observation. The particles of the positive electrode active material were determined based on the type of element under measurement, and the average particle size of the particles of the positive electrode active material were measured.

### Test for Specific Surface Area

According to the national standard “Determination of Specific Surface Area of Solid Substances by Gas Adsorption BET Method” (GB/T 19587-2017), a specific surface area analyzer (model: Tristar II 3020M) was used to test the specific surface area of the positive electrode active material by using the nitrogen adsorption method.

### Porosity Test

The positive electrode plate was punched into small discs with a diameter D of 14 mm, the thickness H of the small disc was measured, and the weight m of the small disc was measured. The small disc was placed into a true density meter (model: Accupyc 111340) for testing to measure the true density V2 of the small disc. Then, the apparent density V1 of the small disc was calculated based on the diameter D and thickness H, where V1=m/[π×(D/2)²×H].

The porosity of the positive electrode plate was calculated as follows:

V0=(V1−V2)/V1×100%.

### Test for Ionic Conductivity

Different solid electrolyte materials were prepared into high-density ceramic sheets (density of 0.96) through cold pressing, and gold was sprayed on two ends of the ceramic sheets to make blocking electrodes. Alternating current impedance test was performed on the prepared blocking electrodes, with a frequency range of 1 MHz to 10 Hz and a perturbation amplitude of 10 mV The ionic conductivity a of the solid electrolyte material was calculated using the following formula: σ=d/Re×S.

In the formula, d was the thickness of the sample under test (in cm); Re was the body impedance of the sample under test (in ohm), which could be obtained from the intersection of the semicircle and the oblique line in the Nyquist diagram (Nyquist diagram) of the electrochemical impedance spectrum; and S was the effective area of the electrode (in cm²).

### Test for Electronic Conductivity

A resistivity tester (model: ST-2255A of Suzhou Lattice Electronics) was used to test the electronic conductivity of the solid electrolyte material. 5 g of the solid electrolyte material powder was taken, and an electric pressing machine was used to press the solid electrolyte material powder into a pellet. The electric pressing machine was maintained at a constant pressure of 5000 kg for 20 s to obtain a solid electrolyte material sample. The solid electrolyte material sample was placed between the electrodes of the resistivity tester for testing.

The electronic conductivity 6 of the solid electrolyte material was

δ=h/(S×R)/1000.

δ was measured in S/m, h was the height of the solid electrolyte material sample (in cm), R was the resistance of the solid electrolyte material sample (in KΩ), and S was the area of the solid electrolyte material sample, where S=3.14 cm².

### Test for Weight Per Unit Area of Positive Electrode Plate

The positive electrode plate prepared in the following examples were punched into small discs with a diameter R as the positive electrode plates, and the weight of the small disc was recorded as m. The weights of aluminum foil small discs with the same diameter were m1, and the mass of the positive electrode material layer was as follows: m2=m−m1. The weight per unit area of the positive electrode plate was as follows: m2/(3.14×(R/2)²).

### Cycling Performance Test

Under the condition of 25° C., the lithium-ion battery was charged to 4.45 V at a constant current of 0.5 C rate, then charged at a constant voltage of 4.45 V until the current was 0.025 C, left standing for 5 min, and then discharged at a constant current of 0.5 C rate to 3.0 V. This was one charge-discharge cycle. The discharge capacity Co after the first cycle was recorded. 500 charge-discharge cycles were conducted in the foregoing manner, and the discharge capacity C₅₀₀ after 500 cycles was recorded.

The capacity retention rate of the lithium-ion battery after 500 cycles was equal to (C₅₀₀/C₀)×100%.

The lithium-ion battery that has undergone formation and been charged to 3.85 V was taken, and a spiral micrometer was used to measure the thickness of the lithium-ion battery at this time, which was the initial thickness T₀. The above cycling test steps were repeated for 500 cycles, so that the lithium-ion battery was kept in a fully charged state of 4.45 V. A spiral micrometer was used to measure the thickness of the lithium-ion battery at this time, which was T₅₀₀.

The thickness swelling rate of the lithium-ion battery after 500 cycles was equal to (T₅₀₀−T₀)/T₀×100%.

### Test for Direct Current Resistance (DCR)

Under the condition of 25° C., the lithium-ion battery was charged to 3.65 V at a constant current of 0.1 C rate, then charged at a constant voltage to 0.025 C, left standing for 10 min, then discharged at a constant current of 0.1 C rate to 2.5 V, left standing for 10 min, then charged to 3.65 V at a constant current of 0.1 C rate, then charged at a constant voltage to 0.025 C, left standing for 10 min, then discharged at a constant current of 0.1 C rate for 5 h (at this time, the state of charge of the lithium-ion battery was 50%), and then discharged at a constant current of 1 C rate for Is. The voltage before the discharge at a constant current of 1 C rate was V0, the voltage after the discharge at a constant current of 1 C rate was V1, and the current of the discharge at a constant current of 1 C rate was A. The direct current resistance corresponding to the 50% state of charge (SOC) of the lithium-ion battery was (V0-V1)/A.

### Test for Rate Performance

Under the ambient temperature of 25° C., the lithium-ion battery was charged to 4.45 V at a constant current of 0.5 C rate, then charged at a constant voltage of 4.45 V until the current was 0.025 C, left standing for 5 min, and then discharged at a constant current of 0.5 C rate to 3 V. The discharge capacity at this time was recorded as the 0.5 C discharge capacity. The battery was left standing for 5 min, then charged to 4.45 V at a constant current of 0.5 C rate, then charged at a constant voltage of 4.45 V until the current was 0.025 C, left standing for 5 min, and then discharged at a constant current of 3 C to 3 V. The discharge capacity at this time was recorded as the 3 C discharge capacity.

3C discharge capacity retention rate (%) of lithium-ion battery=3Cdischarge capacity/0.5C discharge capacity×100%.

### Hot Box Test

First, the lithium-ion battery was pre-treated. The pre-treatment process was as follows: the test temperature was 25° C., and the battery was left standing for 5 min, charged at a constant current of 0.5 C rate to 4.45 V, then charged at a constant voltage of 4.45 V until the current was 0.025 C, and left standing for 60 min. Then, the hot box test was performed. Before the test, the appearance of the lithium-ion battery was checked and photos were taken. A temperature sensing cable was attached. The sample was placed vertically in the box, and heated to the test temperature (130° C.) at a heating speed of 5° C./min and maintained at that temperature for 60 min. The voltage and internal resistance were measured. If the lithium-ion battery did not catch fire or explode, it passed the hot box test.

### Example 1-1

### Preparation of Positive Electrode Active Material

Three raw materials AlPO₄, Ti₃(PO₄)₄, and Li₃PO₄ were mixed in a mass ratio of 3.66:18.81:6.03 to uniformity through ball milling, and then 500 g lithium cobalt oxide was added. The substances were mixed to uniformity through ball milling to obtain a mixture. The mixture was sintered at a high temperature of 800° C. in an air furnace for 4 h, and ground to obtain a positive electrode active material. The positive electrode active material includes a positive electrode active material substrate and a solid electrolyte material. The positive electrode active material substrate is lithium cobalt oxide, and the solid electrolyte material is Li_{1.3}Al_{0.3}Ti_{1.7}(PO₄)₃ (LATP). The ionic conductivity of the above solid electrolyte material LATP was 3.2×10⁻⁴ S/cm, and the electronic conductivity of the above solid electrolyte material LATP was 1.1×10⁻¹¹ S/cm.

### Preparation of Positive Electrode Plate

The prepared positive electrode active material was stirred for 30 min, then a conductive agent acetylene black and a binder polyvinylidene fluoride were added, where the positive electrode active material, acetylene black, and polyvinylidene fluoride were at a mass ratio of 96:2:2, and then N-methyl-2-pyrrolidone (NMP) was added as a solvent to formulate a positive electrode slurry with a solid content of 75 wt %. The slurry was stirred under vacuum to uniformity to obtain a positive electrode slurry. The positive electrode slurry was uniformly applied onto a positive electrode current collector aluminum foil with a thickness of 10 μm and dried at 90° C. to obtain a positive electrode plate having a positive electrode material layer applied on one surface, with a thickness of 100 μm. Then the foregoing steps were repeated on another surface of the aluminum foil to obtain a positive electrode plate coated with positive electrode material layers on two surfaces. The positive electrode plate was dried at 90° C. and then cold pressed, followed by cutting and tab welding, to obtain a 74 mm×867 mm positive electrode plate for later use. The cold pressing pressure was 10 T, and the single-side thickness of the positive electrode material layer after cold pressing was 60 μm. The weight per unit area of the positive electrode plate was 16.8 mg/cm².

### Preparation of Negative Electrode Plate

Artificial graphite and dispersant sodium carboxymethyl cellulose were stirred for 30 min, and then a binder styrene-butadiene rubber (SBR) and a conductive agent acetylene black were added, where the mass ratio of the artificial graphite, sodium carboxymethyl cellulose, styrene-butadiene rubber, and acetylene black was 96:1.5:0.5:2. Deionized water was added as a solvent to formulate a negative electrode slurry with a solid content of 45 wt %, and the slurry was stirred to uniformity under vacuum by using a vacuum stirrer to obtain a negative electrode slurry. The negative electrode slurry was evenly applied on one surface of a negative electrode current collector copper foil having a thickness of 10 μm, and dried at 90° C. to obtain a negative electrode plate having a coating thickness of 100 μm and with one surface coated with the negative electrode material layer. Then the foregoing steps were repeated on another surface of the copper foil to obtain a negative electrode plate coated with negative electrode material layers on two surfaces. The negative electrode plate was dried at 90° C. and then cold pressed, followed by cutting and tab welding, to obtain a negative electrode plate of 78 mm×875 mm for later use. The single-side thickness of the negative electrode material layer after cold pressing was 45 μm.

### Preparation of Separator

A porous polyethylene film (provided by Celgard) having a thickness of 12 m was used.

### Preparation of Electrolyte Solution

In an argon atmosphere glove box with a moisture content of <10 ppm, ethylene carbonate (EC) and diethyl carbonate (DEC) were mixed in a volume ratio of 1:1 to obtain a base solvent, then a lithium salt LiPF₆ and fluoroethylene carbonate (FEC) were added to the base solvent, and the substances were stirred to uniformity to obtain an electrolyte solution. Based on the mass of the electrolyte solution, a weight percentage of the lithium salt was 12%, a weight percentage of fluoroethylene carbonate was 5%, and the base solvent accounted for the remaining proportion.

### Preparation of Lithium-Ion Battery

The positive electrode plate, the separator, the negative electrode plate, and the separator were sequentially stacked so that the separator was located between the positive electrode plate and negative electrode plate to provide separation. Then the resulting stack was wound to obtain an electrode assembly. The electrode assembly was placed into an aluminum-plastic film, the electrolyte solution was then injected, and sealing was performed. Processes such as standing, formation, and shaping were performed to obtain a lithium-ion battery. After the lithium-ion battery was subjected to 500 cycles, based on the mass of the negative electrode material layer, the weight percentage W1 of any one of the first element was as shown in Table 1.

### Examples 1-2 to 1-6

The same as Example 1-1 except that the mass of the solid electrolyte material added was adjusted so that the weight percentage W2 of the solid electrolyte material was as shown in Table 1.

### Example 1-7

The same as Example 1-1 except that the positive electrode active material was prepared according to the following method.

### Preparation of Positive Electrode Active Material

Lithium carbonate, lanthanum oxide, and zirconium oxide were mixed in a mass ratio of 1.46:9.12:11.5 to uniformity through ball milling, and then 500 g lithium cobalt oxide was added. The substances were mixed to uniformity through ball milling to obtain a mixture. The mixture was sintered at a high temperature of 1200° C. in an air furnace for 4 h, and ground to obtain a positive electrode active material. The positive electrode active material included a positive electrode active material substrate and a solid electrolyte material. The positive electrode active material substrate was lithium cobalt oxide, and the solid electrolyte material was Li₇La₃Zr₂O₁₂ (LLZO). The ionic conductivity of the above solid electrolyte material LLZO was 6.7×10⁻⁴ S/cm, and the electronic conductivity of the above solid electrolyte material LLZO was 2.12×10⁻¹¹ S/cm.

### Example 1-8

The same as Example 1-1 except that the positive electrode active material was prepared according to the following method.

### Preparation of Positive Electrode Active Material

Lithium carbonate, lanthanum oxide, and titanium dioxide were mixed in a mass ratio of 1.46:9.12:8 to uniformity through ball milling, and then 500 g lithium cobalt oxide was added. The substances were mixed to uniformity through ball milling to obtain a mixture. The mixture was sintered at a high temperature of 1200° C. in an air furnace for 4 h, and ground to obtain a positive electrode active material. The positive electrode active material included a positive electrode active material substrate and a solid electrolyte material. The positive electrode active material substrate was lithium cobalt oxide, and the solid electrolyte material was Li_{0.33}La_{0.56}TiO₃ (LLTO). The ionic conductivity of the above solid electrolyte material LLTO was 5.9×10⁻⁴ S/cm, and the electronic conductivity of the above solid electrolyte material LLTO was 1.89×10⁻¹¹ S/cm.

### Examples 1-9 and 1-10

The same as Example 1-1 except that the mass of the solid electrolyte material added was adjusted so that the weight percentage W2 of the solid electrolyte material was as shown in Table 1.

### Example 1-11

The same as Example 1-1 except that lithium nickel cobalt manganese oxide (LiNi_{0.8}Co_{0.1}Mn_{0.1}O₂) was used as the positive electrode active material substrate in the <preparation of positive electrode active material>.

### Examples 2-1 to 2-6

The same as Example 1-1 except that the grinding time was adjusted so that the average particle size and specific surface area B of the positive electrode active material were as shown in Table 3.

### Example 2-7 and Example 2-8

The same as Example 1-1 except that the cold pressing pressure was adjusted so that the porosity of the positive electrode plate was as shown in Table 3.

### Example 2-9 and Example 2-10

The same as Example 1-1 except that the grinding time was adjusted so that the average particle size and specific surface area B of the positive electrode active material were as shown in Table 3, and that the cold pressing pressure was adjusted so that the porosity of the positive electrode plate was as shown in Table 3.

### Example 3-1 to Example 3-14

The same as Example 1-1 except that relevant preparation parameters were adjusted according to Table 4 in <preparation of electrolyte solution>. When the weight percentage of the first fluorine-containing lithium salt and/or the weight percentage of the second fluorine-containing lithium salt added changed, the weight percentage of the base solvent changed accordingly, while the weight percentage of the fluoroethylene carbonate and the volume ratio of EC to DEC remained unchanged. Based on the mass of the negative electrode material layer, the weight percentage W7 of the first elements was as shown in Table 4.

### Comparative Example 1

The same as Example 1-1 except that the positive electrode plate was prepared according to the following method.

### Preparation of Positive Electrode Plate

A positive electrode active material lithium cobalt oxide was stirred for 30 min, then a conductive agent acetylene black and a binder polyvinylidene fluoride were added, where the positive electrode active material, acetylene black, and polyvinylidene fluoride were at a mass ratio of 96:2:2, and then N-methyl-2-pyrrolidone (NMP) was added as a solvent to formulate a positive electrode slurry with a solid content of 75 wt %. The slurry was stirred under vacuum to uniformity to obtain a positive electrode slurry. The positive electrode slurry was uniformly applied onto a positive electrode current collector aluminum foil with a thickness of 10 μm and dried at 90° C. to obtain a positive electrode plate having a positive electrode material layer applied on one surface, with a thickness of 100 μm. Then the foregoing steps were repeated on another surface of the aluminum foil to obtain a positive electrode plate coated with positive electrode material layers on two surfaces. The positive electrode plate was dried at 90° C. and then cold pressed, followed by cutting and tab welding, to obtain a 74 mm×867 mm positive electrode plate for later use. The single-side thickness of the positive electrode material layer after cold pressing was 60 μm. The weight per unit area of the positive electrode plate was 16.8 mg/cm².

The preparation parameters and electrical performance parameters of the examples and comparative examples are shown in Tables 1 to 4.

TABLE 1

| | | | | Weight | Weight | | |
|---|---|---|---|---|---|---|---|
| | | | | percentage | percentage | | |
| | | | | of second | of second | | |
| | | Second | Solid | element N | element N | | |
| | First | element | electrolyte | in surface | in internal | W1 | W2 |
| | element | N | material | region (ppm) | region (ppm) | (ppm) | (%) |
| Example 1-1 | Co | Ti | LATP | 10097 | 253 | 582 | 5 |
| Example 1-2 | Co | Ti | LATP | 1077 | 150 | 889 | 0.2 |
| Example 1-3 | Co | Ti | LATP | 4987 | 202 | 867 | 1 |
| Example 1-4 | Co | Ti | LATP | 8732 | 231 | 756 | 3 |
| Example 1-5 | Co | Ti | LATP | 12459 | 301 | 546 | 7 |
| Example 1-6 | Co | Ti | LATP | 19968 | 471 | 508 | 10 |
| Example 1-7 | Co | Zr | LLZO | 11076 | 303 | 569 | 5 |
| Example 1-8 | Co | Ti | LLTO | 10954 | 276 | 575 | 5 |
| Example 1-9 | Co | Ti | LATP | 1045 | 115 | 903 | 0.1 |
| Example 1-10 | Co | Ti | LATP | 19643 | 432 | 502 | 12 |
| Example 1-11 | Ni, Co, | Ti | LATP | 9341 | 222 | 654 | 5 |
| | Mn | | | | | | |
| Comparative | Co | / | / | / | / | 1205 | / |
| Example 1 | | | | | | | |

| | | | | | Ionic | Electronic |
|---|---|---|---|---|---|---|
| | | | | | conductivity | conductivity |
| | | | | | of solid | of solid |
| | | | | | electrolyte | electrolyte |
| | W3 | W4 | W5 | W6 | material | material |
| | (ppm) | (ppm) | (ppm) | (ppm) | (S/cm) | (S/cm) |
| Example 1-1 | 1055 | / | 10631 | / | 3.2 × 10⁻⁴ | 1.1 × 10⁻¹¹ |
| Example 1-2 | 42 | / | 425 | / | 3.12 × 10⁻⁴ | 1.2 × 10⁻¹¹ |
| Example 1-3 | 211 | / | 2126 | / | 3.18 × 10⁻⁴ | 1.12 × 10⁻¹¹ |
| Example 1-4 | 633 | / | 6378 | / | 3.22 × 10⁻⁴ | 1.14 × 10⁻¹¹ |
| Example 1-5 | 1477 | / | 14883 | / | 3.14 × 10⁻⁴ | 1.19 × 10⁻¹¹ |
| Example 1-6 | 2110 | / | 21261 | / | 3.3 × 10⁻⁴ | 1.16 × 10⁻¹¹ |
| Example 1-7 | / | 24801 | / | 10856 | 6.7 × 10⁻⁴ | 2.12 × 10⁻¹¹ |
| Example 1-8 | / | 22086 | 13629 | / | 5.9 × 10⁻⁴ | 1.89 × 10⁻¹¹ |
| Example 1-9 | 21 | / | 213 | / | 3.23 × 10⁻⁴ | 1.3 × 10⁻¹¹ |
| Example 1-10 | 2533 | / | 25513 | / | 3.15 × 10⁻⁴ | 1.23 × 10⁻¹¹ |
| Example 1-11 | 1055 | / | 10631 | / | 3.24 × 10⁻⁴ | 1.18 × 10⁻¹¹ |
| Comparative | / | / | / | / | / | / |
| Example 1 | | | | | | |

Note:
In Table 1, “/” indicates no relevant preparation parameters.

TABLE 2

| | | Discharge | | | |
|---|---|---|---|---|---|
| | | capacity | | Capacity | Thickness |
| | | retention | | retention rate | swelling rate |
| | DCR | rate | | after 500 | after 500 |
| | (mΩ) | at 3 C (%) | Hot box | cycles (%) | cycles (%) |
| Example | 46.5 | 93.50 | 10 passed | 86.20 | 9.8 |
| 1-1 | | | out of 10 | | |
| Example | 53.2 | 92.80 | 8 passed | 84.5 | 10.5 |
| 1-2 | | | out of 10 | | |
| Example | 51.3 | 92.96 | 9 passed | 85.6 | 10.4 |
| 1-3 | | | out of 10 | | |
| Example | 50.1 | 93.20 | 10 passed | 85.9 | 10.2 |
| 1-4 | | | out of 10 | | |
| Example | 44.6 | 93.80 | 10 passed | 86.7 | 9.7 |
| 1-5 | | | out of 10 | | |
| Example | 41.9 | 94.10 | 10 passed | 86.8 | 9.4 |
| 1-6 | | | out of 10 | | |
| Example | 44.3 | 93.60 | 10 passed | 87.1 | 9.5 |
| 1-7 | | | out of 10 | | |
| Example | 43.2 | 93.56 | 10 passed | 87 | 9.6 |
| 1-8 | | | out of 10 | | |
| Example | 55.3 | 92.40 | 7 passed | 83.2 | 10.7 |
| 1-9 | | | out of 10 | | |
| Example | 40.9 | 94.20 | 10 passed | 83.9 | 10.8 |
| 1-10 | | | out of 10 | | |
| Example | 39.2 | 94.3 | 8 passed | 83.2 | 10.7 |
| 1-11 | | | out of 10 | | |
| Comparative | 60.3 | 91.50 | 2 passed | 71.4 | 13 |
| Example 1 | | | out of 10 | | |

Note:
In Table 2, Example 1-1 is used as an example, and “10 passed out of 10” under hot box means that among 10 lithium-ion batteries tested in the hot box test, 10 lithium-ion batteries neither caught fire nor exploded, meaning that 10 lithium-ion batteries passed the hot box test. The same applies to other examples and comparative examples.

Refer to Tables 1 and 2. From Examples 1-1 to 1-11 and Comparative Example 1, it can be seen hat with the positive electrode active material controlled to include the positive electrode active material substrate and the solid electrolyte material, the positive electrode active material substrate controlled to include the first element and the solid electrolyte material controlled to include the second element, and the weight percentage of any one of the at least one second element in the surface region and the weight percentage of any one of the at least one second element in the internal region controlled to fall within the ranges specified in this application, the lithium-ion battery has lower DCR, higher 3 C discharge capacity retention rate, more hot box passes, higher capacity retention rate after 500 cycles, and lower thickness swelling rate after 500 cycles. This indicates that the lithium-ion battery has lower impedance and good rate performance, cycling performance, and safety performance. In Comparative Example 1, the lithium-ion battery has higher DCR, lower 3 C discharge capacity retention rate, fewer hot box passes, lower capacity retention rate after 500 cycles, and higher thickness swelling rate after 500 cycles. This indicates that the lithium-ion battery has higher impedance and relatively poor rate performance, cycling performance, and safety performance.

The weight percentage W2 of the solid electrolyte material typically affects the impedance, rate performance, cycling performance, and safety performance of the lithium-ion battery. From Examples 1-1 to 1-6, 1-9, and 1-10, it can be seen that with the weight percentage W2 of the solid electrolyte material controlled to fall within the range specified in this application, the lithium-ion battery has lower DCR, higher 3 C discharge capacity retention rate, more hot box passes, higher capacity retention rate after 500 cycles, and lower thickness swelling rate after 500 cycles. This indicates that the lithium-ion battery has lower impedance and good rate performance, cycling performance, and safety performance.

The type of solid electrolyte material typically affects the impedance, rate performance, cycling performance, and safety performance of the lithium-ion battery. From Examples 1-1, 1-7, and 1-8, it can be seen that with the type of solid electrolyte material controlled to fall within the range specified in this application, the lithium-ion battery has lower DCR, higher 3 C discharge capacity retention rate, more hot box passes, higher capacity retention rate after 500 cycles, and lower thickness swelling rate after 500 cycles. This indicates that the lithium-ion battery has lower impedance and good rate performance, cycling performance, and safety performance.

Manufacture multiple identical lithium-ion batteries according to the preparation steps of Example 1-1, and in the test for the weight percentage of the first elements, 100 cycles, 300 cycles, 700 cycles, 1000 cycles, and 1500 cycles were conducted respectively. The tested weight percentages W1 of the first element were 500 ppm, 548 ppm, 635 ppm, 760 ppm, and 943 ppm, respectively.

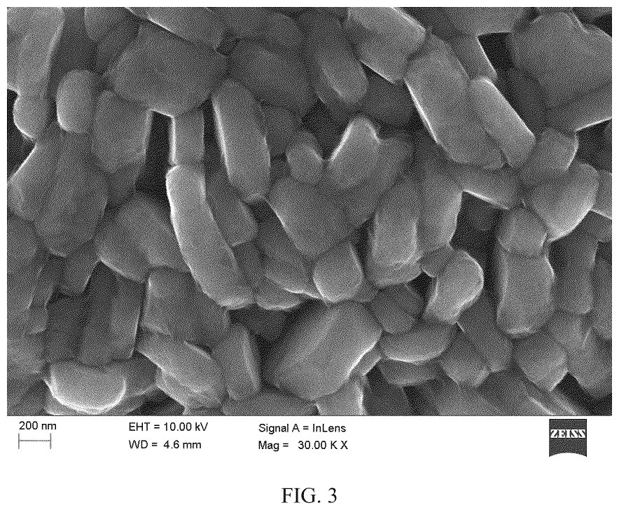

It can be seen from FIGS. 2 and 3 that in Example 1-1 of this application, the solid electrolyte material is present on the surface of the positive electrode active material substrate, and the solid electrolyte material takes the form of a film.

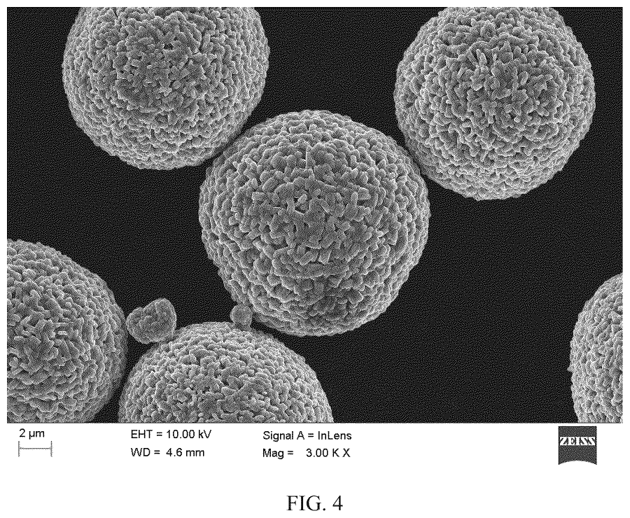

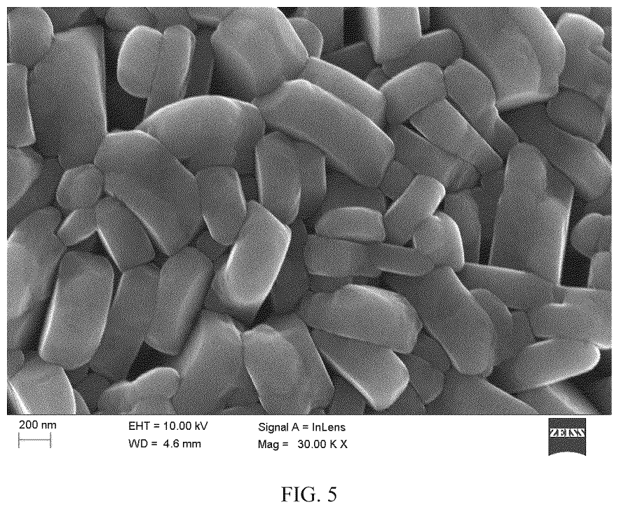

It can be seen from FIGS. 4 and 5 that in Comparative Example 1, the solid electrolyte material is not present on the surface of the positive electrode active material substrate.

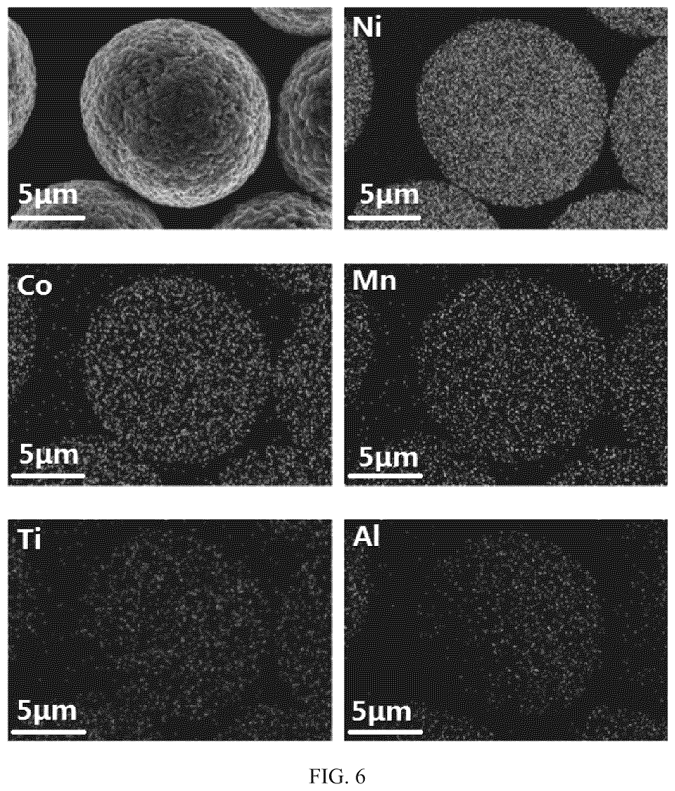

It can be seen from FIG. 6 that in Example 1-11 of this application, the elements of the positive electrode active material substrate and the solid electrolyte material in the positive electrode active material of the positive electrode plate are evenly distributed.

A scanning electron microscope and energy spectrum analyzer is used to perform line scan on the particles of the positive electrode active material in a cross-section of the positive electrode material layer in Example 1-1. The line scan includes three straight lines, the three straight lines intersect each other at an angle of 60°, and the three straight lines are 30 μm in length. In a line scan spectrum of each straight line, there are 3 first peaks of element Co, 6 second peaks of element Al, 6 second peaks of element Ti, and 6 second peaks of element P. A peak top region of the first peak corresponds to a peak top region of the second peak. The line scan spectrum meeting the above characteristic indicates that the solid electrolyte material is present on the surface of the positive electrode active material substrate and that the solid electrolyte material is uniformly distributed on the surface of the positive electrode active material substrate. This can improve lithium-ion conduction inside the positive electrode plate, reduce side reactions between the positive electrode active material and the electrolyte solution, and improve the cycling performance, rate performance, and safety performance of the lithium-ion battery.

TABLE 3

| | Average particle | | Porosity of | | Discharge | | Capacity | Thickness |
|---|---|---|---|---|---|---|---|---|
| | size of positive | | positive | | capacity | | retention rate | swelling rate |
| | electrode active | B | electrode | DCR | retention rate | | after 500 | after 500 |
| | material (μm) | (m²/g) | plate (%) | (mΩ) | at 3 C (%) | Hot box | cycles (%) | cycles (%) |
| Example 1-1 | 14.3 | 0.34 | 23.4 | 46.5 | 93.50 | 10 passed | 86.20 | 9.8 |
| | | | | | | out of 10 | | |
| Example 2-1 | 5 | 0.43 | 21.8 | 54.6 | 93.45 | 8 passed | 86.1 | 9.9 |
| | | | | | | out of 10 | | |
| Example 2-2 | 8 | 0.41 | 22.1 | 45.8 | 93.7 | 10 passed | 86.5 | 9.7 |
| | | | | | | out of 10 | | |
| Example 2-3 | 15 | 0.33 | 23.3 | 46.4 | 93.76 | 10 passed | 86.6 | 9.5 |
| | | | | | | out of 10 | | |
| Example 2-4 | 20 | 0.28 | 23.8 | 45.9 | 93.75 | 10 passed | 86.53 | 9.6 |
| | | | | | | out of 10 | | |
| Example 2-5 | 30 | 0.21 | 24.1 | 52.4 | 93.4 | 10 passed | 85.9 | 10.1 |
| | | | | | | out of 10 | | |
| Example 2-6 | 1.2 | 0.8 | 23.8 | 58.3 | 93.2 | 3 passed | 85.3 | 10.3 |
| | | | | | | out of 10 | | |
| Example 2-7 | 14.3 | 0.34 | 18 | 59.2 | 92.1 | 10 passed | 81.3 | 11.2 |
| | | | | | | out of 10 | | |
| Example 2-8 | 14.3 | 0.34 | 30 | 44.3 | 93.8 | 10 passed | 87.1 | 11.4 |
| | | | | | | out of 10 | | |
| Example 2-9 | 35 | 0.18 | 25.6 | 56.4 | 92.11 | 10 passed | 84.4 | 10.7 |
| | | | | | | out of 10 | | |
| Example 2-10 | 0.89 | 1 | 20.2 | 60.1 | 92.4 | 2 passed | 84.8 | 10.6 |
| | | | | | | out of 10 | | |

The average particle size of the positive electrode active material typically affects the impedance, rate performance, cycling performance, and safety performance of the lithium-ion battery. From Examples 1-1, 2-1 to 2-6, 2-9, and 2-10, it can be seen that with the average particle size of the positive electrode active material controlled to fall within the range specified in this application, the lithium-ion battery has lower DCR, higher 3 C discharge capacity retention rate, more hot box passes, higher capacity retention rate after 500 cycles, and lower thickness swelling rate after 500 cycles. This indicates that the lithium-ion battery has lower impedance and good rate performance, cycling performance, and safety performance. Compared with Example 2-7, in Example 2-9, the average particle size of the positive electrode active material is relatively larger and the specific surface area thereof is relatively smaller; and the porosity of the positive electrode plate is relatively larger and the compacted density thereof is relatively lower. This results in a relatively lower energy density of the lithium-ion battery.

The specific surface area B of the positive electrode active material typically affects the impedance, rate performance, cycling performance, and safety performance of the lithium-ion battery. From Examples 1-1, 2-1 to 2-6, 2-9, and 2-10, it can be seen that with the specific surface area B of the positive electrode active material controlled to fall within the range specified in this application, the lithium-ion battery has lower DCR, higher 3 C discharge capacity retention rate, more hot box passes, higher capacity retention rate after 500 cycles, and lower thickness swelling rate after 500 cycles. This indicates that the lithium-ion battery has lower impedance and good rate performance, cycling performance, and safety performance.

The porosity of the positive electrode plate typically affects the impedance, rate performance, cycling performance, and safety performance of the lithium-ion battery. From Examples 1-1, 2-7, and 2-8, it can be seen that with the porosity of the positive electrode plate controlled to fall within the range specified in this application, the lithium-ion battery has lower DCR, higher 3 C discharge capacity retention rate, more hotbox passes, higher capacity retention rate after 500 cycles, and lower thickness swelling rate after 500 cycles. This indicates that the lithium-ion battery has lower impedance and good rate performance, cycling performance, and safety performance.

TABLE 4

| | Weight | | Weight | | | | | | | |
|---|---|---|---|---|---|---|---|---|---|---|
| | percentage | | percentage | | | | | | | |
| | A1 of | | A2 of | | | | | | | |
| | first | | second | | | | Discharge | | Capacity | Thickness |
| | fluorine- | | fluorine- | | | | capacity | | retention | swelling |
| | Containing | | containing | | | | retention | | rate after | rate after |
| | lithium | Second fluorine- | lithium | W7 | | DCR | rate at 3 C | | 500 cycles | 500 cycles |
| | salt (%) | containing lithium salt | salt (%) | (%) | A2 × W7 | (mΩ) | (%) | Hot box | (%) | (%) |
| Example | 12 | / | / | 0.05 | / | 46.5 | 93.50 | 10 passed | 86.20 | 9.8 |
| 1-1 | | | | | | | | out of 10 | | |
| Example | 15 | Lithium | 5 | 0.046 | 2.30 × 10⁻⁵ | 44.5 | 93.9 | 10 passed | 86.90 | 9.6 |
| 3-1 | | bis(fluorosulfonyl)imide | | | | | | out of 10 | | |
| Example | 4.6 | Lithium | 5 | 0.057 | 2.85 × 10⁻⁵ | 47.5 | 93.10 | 10 passed | 86.10 | 10.1 |
| 3-2 | | bis(fluorosulfonyl)imide | | | | | | out of 10 | | |
| Example | 22.09 | Lithium | 5 | 0.041 | 2.05 × 10⁻⁵ | 46.1 | 93.40 | 10 passed | 85.70 | 10.3 |
| 3-3 | | bis(fluorosulfonyl)imide | | | | | | out of 10 | | |
| Example | 15 | Lithium | 5 | 0.045 | 2.25 × 10⁻⁵ | 44.6 | 93.8 | 10 passed | 86.80 | 9.5 |
| 3-4 | | bis(trifluoromethylsulfonyl)imide | | | | | | out of 10 | | |
| Example | 15 | Lithium tetrafluoroborate | 5 | 0.04 | 2.00 × 10⁻⁵ | 44.4 | 94 | 10 passed | 87.10 | 9.7 |
| 3-5 | | | | | | | | out of 10 | | |
| Example | 15 | Lithium difluorophosphate | 5 | 0.048 | 2.40 × 10⁻⁵ | 44.7 | 93.6 | 10 passed | 86.70 | 9.9 |
| 3-6 | | | | | | | | out of 10 | | |
| Example | 15 | Lithium | 0.46 | 0.048 | 2.21 × 10⁻⁶ | 46.7 | 93.1 | 10 passed | 86.20 | 10.2 |
| 3-7 | | bis(fluorosulfonyl)imide | | | | | | out of 10 | | |
| Example | 15 | Lithium | 11.1 | 0.036 | 4.00 × 10⁻⁵ | 42.5 | 94.2 | 10 passed | 85.90 | 9.7 |
| 3-8 | | bis(fluorosulfonyl)imide | | | | | | out of 10 | | |
| Example | 3 | Lithium | 5 | 0.064 | 3.20 × 10⁻⁵ | 49.6 | 91.8 | 9 passed | 83.80 | 11.2 |
| 3-9 | | bis(fluorosulfonyl)imide | | | | | | out of 10 | | |
| Example | 25 | Lithium | 5 | 0.018 | 9.00 × 10⁻⁶ | 49.4 | 91.2 | 10 passed | 84.20 | 10.9 |
| 3-10 | | bis(fluorosulfonyl)imide | | | | | | out of 10 | | |
| Example | 15 | Lithium | 0.2 | 0.045 | 9.00 × 10⁻⁷ | 48.6 | 92.1 | 10 passed | 84.80 | 10.6 |
| 3-11 | | bis(fluorosulfonyl)imide | | | | | | out of 10 | | |
| Example | 15 | Lithium | 14 | 0.019 | 2.66 × 10⁻⁵ | 50.1 | 91.1 | 10 passed | 83.60 | 10.8 |
| 3-12 | | bis(fluorosulfonyl)imide | | | | | | out of 10 | | |
| Example | 3.5 | Lithium | 15 | 0.043 | 6.45 × 10⁻⁵ | 49.2 | 91.3 | 10 passed | 83.6 | 11.7 |
| 3-13 | | bis(fluorosulfonyl)imide | | | | | | out of 10 | | |
| Example | 24 | Lithium | 0.2 | 0.031 | 6.20 × 10⁻⁷ | 49.3 | 90.8 | 10 passed | 83.7 | 11.3 |
| 3-14 | | bis(fluorosulfonyl)imide | | | | | | out of 10 | | |

Note:
In Table 4, “/” indicates no relevant preparation parameters.

The electrolyte solution including the lithium salt, the lithium salt including the first fluorine-containing lithium salt and the second fluorine-containing lithium salt, the type and proportion of the first fluorine-containing lithium salt, and the type and proportion of the second fluorine-containing lithium salt typically affect the impedance, rate performance, cycling performance, and safety performance of the lithium-ion battery. From Examples 3-1 to 3-14, it can be seen that with the electrolyte solution controlled to include lithium salts, the lithium salt controlled to include the first fluorine-containing lithium salt and the second fluorine-containing lithium salt, and the type and proportion of the first fluorine-containing lithium salt and the type and proportion of the second fluorine-containing lithium salt controlled to fall within the ranges specified in this application, the lithium-ion battery has lower DCR, higher 3 C discharge capacity retention rate, more hot box passes, higher capacity retention rate after 500 cycles, and lower thickness swelling rate after 500 cycles. This indicates that the lithium-ion battery has lower impedance and good rate performance, cycling performance, and safety performance.

The product of the weight percentage A2 of the second fluorine-containing lithium salt and the weight percentage W7 of the first element typically affects the impedance, rate performance, cycling performance, and safety performance of the lithium-ion battery. From Examples 3-1 to 3-14, it can be seen that with the product of the weight percentage A2 of the second fluorine-containing lithium salt and the weight percentage W7 of the first element controlled to fall within the range specified in this application, the lithium-ion battery has lower DCR, higher 3 C discharge capacity retention rate, more hot box passes, higher capacity retention rate after 500 cycles, and lower thickness swelling rate after 500 cycles. This indicates that the lithium-ion battery has lower impedance and good rate performance, cycling performance, and safety performance.

The foregoing descriptions are merely preferred embodiments of this application, but are not intended to limit this application. Any modification, equivalent replacement, or improvement made without departing from the spirit and principle of this application shall fall within the protection scope of this application.

1. A secondary battery, comprising a positive electrode plate, a negative electrode plate, and an electrolyte solution; wherein the positive electrode plate comprises a positive electrode current collector and a positive electrode material layer disposed on at least one surface of the positive electrode current collector; wherein the positive electrode material layer comprises a positive electrode active material; wherein the positive electrode active material comprises a positive electrode active material substrate and a solid electrolyte material, and at least a part of the solid electrolyte material is disposed on a surface of the positive electrode active material substrate; wherein
the positive electrode active material substrate comprises a first element; wherein the first element comprises at least one of Ni, Mn, Fe, or Co; and the solid electrolyte material comprises a second element; wherein the second element comprises at least one of Al, Ge, Sr, Hf, Si, Zn, Cl, I, Mg, Ca, Ba, La, Ti, Zr, P, or Ta;
a particle of the positive electrode active material comprise a surface region and an internal region, wherein the surface region is a region from a surface of the particle to a depth of M nm inside the particle, 1≤M≤300, and the internal region is a region of the particle other than the surface region; and
based on a weight of the positive electrode active material, a weight percentage of any one of the second element in the surface region is 1000 ppm to 20000 ppm, and a weight percentage of any one of the second element in the internal region is less than 500 ppm.

2. The secondary battery according to claim 1, wherein based on a weight of the positive electrode material layer, a weight percentage of the solid electrolyte material is W2, W2 ranges from 0.2% to 10%.

3. The secondary battery according to claim 1, wherein the positive electrode material layer comprises Al; and based on a weight of the positive electrode material layer, a weight percentage of Al is W3, W3 ranges from 42 ppm to 3000 ppm.

4. The secondary battery according to claim 1, wherein the positive electrode material layer comprises La; and based on a weight of the positive electrode material layer, a weight percentage of La is W4, W4 ranges from 1600 ppm to 50000 ppm.

5. The secondary battery according to claim 1, wherein the positive electrode material layer comprises Ti; and based on a weight of the positive electrode material layer, a weight percentage of Ti is W5, W5 ranges from 425 ppm to 35000 ppm.

6. The secondary battery according to claim 1, wherein the positive electrode material layer comprises Zr; and based on a weight of the positive electrode material layer, a weight percentage of Zr is W6, W6 ranges from 720 ppm to 25000 ppm.

7. The secondary battery according to claim 1, wherein an average particle size of the positive electrode active material is 5 μm to 30 μm.

8. The secondary battery according to claim 7, wherein the average particle size of the positive electrode active material is 8 μm to 20 μm.

9. The secondary battery according to claim 1, wherein a specific surface area of the positive electrode active material is B, B ranges from 0.2 m²/g to 0.8 m²/g.

10. The secondary battery according to claim 9, wherein B ranges from 0.28 m²/g to 0.41 m²/g.

11. The secondary battery according to claim 1, wherein a porosity of the positive electrode plate is 18% to 30%.

12. The secondary battery according to claim 1, wherein the solid electrolyte material comprises at least one selected from the group consisting of the following compounds and the following compounds with a doping element: NASICON-structured Li₁₊ₓ₁Alₓ₁Ge₂₋ₓ₁(PO₄)₃, NASICON-structured Li₁₊ₓ₂Alₓ₂Ti₂₋ₓ₂(PO₄)₃, perovskite-structured Li₃ₓ₃La_{2/3-x3}TiO₃, perovskite-structured Li_{3/8}Sr_{7/16}Ta_{3/4}Hf_{1/4}O₃, perovskite-structured Li_{2x4-y1}Sr₁₋ₓ₄Ta_{y1}Zr_{1-y1}O₃, anti-perovskite-structured Li₃₋₂ₓ₅Mₓ₅HalO, anti-perovskite-structured Li₃OCl, LISICON-structured Li₄₋ₓ₆Si₁₋ₓ₆Pₓ₆O₄, LISICON-structured Li₁₄ZnGe₄O₁₆, and garnet-structured Li₇₋ₓ₇La₃Zr₂₋ₓ₇O₁₂, wherein 0<x1≤0.75, 0<x2≤0.5, 0.1≤x3≤0.3, 0.25≤y1≤1, x4=0.75y1, 0≤x5≤0.01, 0.5≤x6≤0.6, 0≤x7<1; wherein M comprises at least one of Mg, Ca, Sr, or Ba; Hal comprises at least one of Cl or I; and the doping element comprises at least one of Sn, Si, Ge, Sr, Ta, or Ce.

13. The secondary battery according to claim 1, wherein an ionic conductivity of the solid electrolyte material is 8×10⁻⁵ S/cm to 1×10⁻³ S/cm.

14. The secondary battery according to claim 1, wherein an electronic conductivity of the solid electrolyte material is 1×10⁻¹⁴ S/cm to 1×10⁻⁸ S/cm.

15. The secondary battery according to claim 1, wherein the electrolyte solution comprises a lithium salt; wherein the lithium salt comprises a first fluorine-containing lithium salt and a second fluorine-containing lithium salt; wherein the first fluorine-containing lithium salt comprises lithium hexafluorophosphate; and the second fluorine-containing lithium salt comprises at least one selected from the group consisting of lithium bis(fluorosulfonyl)imide, lithium bis(trifluoromethylsulfonyl)imide, lithium tetrafluoroborate, lithium difluorooxalate borate, lithium bis(oxalate)borate, and lithium difluorophosphate; wherein
based on a weight of the electrolyte solution, a weight percentage of the first fluorine-containing lithium salt is Al, Al ranges from 4.6% to 22.09%, and a weight percentage of the second fluorine-containing lithium salt is A2, A2 ranges from 0.46% to 11.1%.

16. The secondary battery according to claim 15, wherein based on a weight of the negative electrode material layer, a weight percentage of the first element is W7, W7 ranges from 0.01% to 0.1%, wherein 4.6×10⁻⁷≤A2×W7≤1.11×10⁻⁴.

17. An electronic apparatus, comprising a secondary battery; wherein the secondary battery comprises a positive electrode plate, a negative electrode plate, and an electrolyte solution; wherein the positive electrode plate comprises a positive electrode current collector and a positive electrode material layer disposed on at least one surface of the positive electrode current collector, the positive electrode material layer comprises a positive electrode active material, the positive electrode active material comprises a positive electrode active material substrate and a solid electrolyte material, and at least a part of the solid electrolyte material is disposed on a surface of the positive electrode active material substrate; wherein
the positive electrode active material substrate comprises a first element, wherein the first element comprises at least one of Ni, Mn, Fe, or Co; and the solid electrolyte material comprises a second element, wherein the second element comprises at least one of Al, Ge, Sr, Hf, Si, Zn, Cl, I, Mg, Ca, Ba, La, Ti, Zr, P, or Ta;
a particle of the positive electrode active material comprise a surface region and an internal region, wherein the surface region is a region from a surface of the particle to a depth of M nm inside the particle, 1≤M≤300, and the internal region is a region of the particle other than the surface region; and
based on a weight of the positive electrode active material, a weight percentage of any one of the second element in the surface region is 1000 ppm to 20000 ppm, and a weight percentage of any one of the second element in the internal region is less than 500 ppm.

18. The electronic apparatus according to claim 17, wherein the solid electrolyte material comprises at least one selected from the group consisting of the following compounds and the following compounds with a doping element: NASICON-structured Li₁₊ₓ₁Alₓ₁Ge₂₋ₓ₁(PO₄)₃, NASICON-structured Li₁₊ₓ₂Alₓ₂Ti₂₋ₓ₂(PO₄)₃, perovskite-structured Li₃ₓ₃La_{2/3-x3}TiO₃, perovskite-structured Li_{3/8}Sr_{7/16}Ta_{3/4}Hf_{1/4}O₃, perovskite-structured Li_{2x4-y1}Sr₁₋ₓ₄Ta_{y1}Zr_{1-y1}O₃, anti-perovskite-structured Li₃₋₂ₓ₅Mₓ₅HalO, anti-perovskite-structured Li₃OCl, LISICON-structured Li₄₋ₓ₆Si₁₋ₓ₆Pₓ₆O₄, LISICON-structured Li₁₄ZnGe₄O₁₆, and garnet-structured Li₇₋ₓ₇La₃Zr₂₋ₓ₇O₁₂, wherein 0<x1≤0.75, 0<x2≤0.5, 0.1≤x3≤0.3, 0.25≤y1≤1, x4=0.75y1, 0≤x5≤0.01, 0.5≤x6≤0.6, 0≤x7≤1; M comprises at least one of Mg, Ca, Sr, or Ba; and Hal comprises at least one of Cl or I;
and the doping element comprises at least one of Sn, Si, Ge, Sr, Ta, or Ce.

19. The electronic apparatus according to claim 17, wherein the electrolyte solution comprises a lithium salt, the lithium salt comprises a first fluorine-containing lithium salt and a second fluorine-containing lithium salt; the first fluorine-containing lithium salt comprises lithium hexafluorophosphate; and the second fluorine-containing lithium salt comprises at least one selected from the group consisting of lithium bis(fluorosulfonyl)imide, lithium bis(trifluoromethylsulfonyl)imide, lithium tetrafluoroborate, lithium difluorooxalate borate, lithium bis(oxalate)borate, and lithium difluorophosphate; wherein
based on a weight of the electrolyte solution, a weight percentage of the first fluorine-containing lithium salt is Al, Al ranges from 4.6% to 22.09%, and a weight percentage of the second fluorine-containing lithium salt is A2, A2 ranges from 0.46% to 11.1%.

20. The electronic apparatus according to claim 19, wherein based on a weight of the negative electrode material layer, a weight percentage of the first element is W7, W7 ranges from 0.01% to 0.1%, wherein 4.6×10⁻⁷≤A2×W7≤1.11×10⁻⁴.
